(19) United States
(12) Patent Application Publication
(10) Pub. No.: US 2015/0023568 A1
(43) Pub. Date: Jan. 22, 2015

(54) COMPUTING SYSTEMS, COMPUTER-READABLE MEDIA AND METHODS OF ANTIBODY PROFILING

(71) Applicant: Battelle Energy Alliance, LLC, Idaho Falls, ID (US)

(72) Inventors: Jeffrey A. Lacey, Idaho Falls, ID (US); Steve Marmer, Mississauga (CA); David Max Woodhead, Acton (CA); Shawna Park, Atlanta, GA (US)

(73) Assignee: Battelle Energy Alliance, LLC, Idaho Falls, ID (US)

(21) Appl. No.: 14/209,720

(22) Filed: Mar. 13, 2014

Related U.S. Application Data
(60) Provisional application No. 61/786,961, filed on Mar. 15, 2013.

(51) Int. Cl. G06K 9/00; G06T 7/00

(52) U.S. Cl. CPC G06K 9/00885; G06T 7/0012; G06T 2207/10061; G06T 2207/30072; G06K 2209/07
USPC 382/115

(57) ABSTRACT

Computing systems, computer-readable media and methods are disclosed. In the computing system, an image capture device captures an image of a protein array including spots of predetermined proteins, wherein some of the spots have bound to a biological material having individual-specific antibodies to form immune complexes and some of the immune complexes have interacted with a detection agent to generate a visible image therefrom. The computing system may be operably coupled to the image capture device and processes the captured image of the protein array to determine control locations of a plurality of control spots in known locations on the protein array. The computing system also extrapolates expected locations of all other spots on the protein array from the control locations.

### CROSS-REFERENCE TO RELATED APPLICATION

This application claims the benefit of U.S. Provisional Application No. 61/786,961, filed on Mar. 15, 2013, for COMPUTING SYSTEMS, COMPUTER-READABLE MEDIA AND METHODS OF ANTIBODY PROFILING, the entire contents of which is incorporated by reference herein. Also, this application is related to U.S. patent application Ser. No. 13/832,406 for ANTIBODY PROFILING, METHODS AND APPARATUS FOR IDENTIFYING AN INDIVIDUAL OR SOURCE OF A BIOLOGICAL MATERIAL, filed Mar. 15, 2013, U.S. patent application Ser. No. 12/883,002, filed Sep. 15, 2010, for IDENTIFICATION OF DISCRIMINANT PROTEINS THROUGH ANTIBODY PROFILING, METHODS AND APPARATUS FOR IDENTIFYING AN INDIVIDUAL, and U.S. patent application Ser. No. 12/586,109, filed Sep. 17, 2009, for “IDENTIFICATION OF DISCRIMINANT PROTEINS THROUGH ANTIBODY PROFILING, METHODS AND APPARATUS FOR IDENTIFYING AN INDIVIDUAL,” the entire contents for each of which are incorporated herein by this reference.

### GOVERNMENT RIGHTS

This invention was made with government support under Contract Number DE-AC07-05ID14517 awarded by the United States Department of Energy. The government has certain rights in the invention.

### FIELD

Embodiments of the present disclosure relate to analyzing biological samples to identify proteins useful in identifying individuals, and more particularly, to methods and apparatus for identifying an individual using such proteins.

### BACKGROUND

The importance of differentiating and identifying individuals based on biological samples with a high degree of efficiency and accuracy is presented in various contexts. For example, the need for accurate means of identification is of increasing importance in law enforcement as it may be critical to link an individual to a forensic sample, such as blood, tissue, hair, saliva, or the like.

### SUMMARY

A method for identifying a source of a biological material, that includes capturing an image of a protein array including spots of predetermined proteins, wherein some of the spots have bound to a sample of a biological material having individual-specific antibodies to form immune complexes and some of the immune complexes have interacted with a detection agent to generate a visible image therefrom; processing the captured image of the protein array to determine control locations of a plurality of control spots at known locations on the protein array; and extrapolating expected locations of all other spots on the protein array from the control locations.

A system, that includes an image capture device configured to capture an image of a protein array including spots of predetermined proteins, wherein some of the spots have bound to a biological material having individual-specific antibodies to form immune complexes and some of the immune complexes have interacted with a detection agent to generate a visible image therefrom; and a computing system configured to be operably coupled to the image capture device and configured to: process the captured image of the protein array to determine control locations of a plurality of control spots in known locations on the protein array; and extrapolate expected locations of all other spots on the protein array from the control locations.

A computer-readable medium including computer-executable instructions, which when executed on one or more processors, cause the processor to: receive a captured image of a protein array including spots of predetermined proteins, wherein some of the spots have bound to a sample of a biological material having individual-specific antibodies to form immune complexes and some of the immune complexes have interacted with a detection agent to generate a visible image therefrom; process the captured image of the protein array to determine control locations of a plurality of control spots at known locations on the protein array; and extrapolating expected locations of all other spots on the protein array from the control locations.

### BRIEF DESCRIPTION OF THE DRAWINGS

While the specification concludes with claims particularly pointing out and distinctly claiming that which is regarded as the present invention, advantages of this disclosure may be more readily ascertained from the following description of the disclosure when read in conjunction with the accompanying drawings in which:

FIG. 1 shows of a protein array according to an embodiment of the present disclosure;

FIG. 2 shows a protein array including control spots and volume assessment spots according to one or more embodiments of the present disclosure;

FIG. 3 shows a super array including three protein arrays according to one or more embodiments of the present disclosure;

FIG. 4 is a simplified diagram of a system for capturing and analyzing, image information for protein arrays;

FIGS. 5A and 5B are images of a loading template and an image capture device in the form of a scanner for capturing image information for a plurality of protein arrays;

FIG. 6 shows a protein array with alignment lines relative to control spots;

FIG. 7, is an image of a portion of a protein array showing superimposed alignment lines and spot locator boxes;

FIG. 8 shows a spot with alignment lines and identification circles for identifying image locations of the spot and background relative to the spot; and

FIG. 9 is a screen shot of a Graphical User Interface (GUI) illustrating a captured image of a protein array and a graph of intensity values for spots in the protein array.

### DETAILED DESCRIPTION

Before embodiments of the present disclosure are described in detail, it is to be understood that this disclosure is not limited to the particular configurations, process acts, and materials disclosed herein as such configurations, process acts, and materials may vary somewhat. It is also to be understood that the terminology employed herein is used for the purpose of describing particular embodiments only and is not limiting since the scope of the present invention will be limited only by the appended claims and equivalents thereof.

The publications and other reference materials referred to herein describe the background of the disclosure and provide additional detail regarding its practice. The references discussed herein are provided solely for their disclosure prior to the filing date of the present application. Nothing herein is to be construed as an admission that such documents constitute prior art, or that the inventors are not entitled to antedate such disclosure by virtue of prior invention.

While the known methods for using antibody profiling are generally suitable for their limited purposes, they possess certain inherent deficiencies that detract from their overall utility in analyzing, characterizing, and identifying biological samples. For example, the known methods rely on fractionation of antigens by electrophoresis and then transfer of the fractionated antigens to a membrane. Due to differences in conditions from one fractionation procedure to another, there are lot-to-lot differences in the positions of the antigens on the membrane such that results obtained using membranes from one lot cannot be compared with results obtained using membranes from another lot. Further, when colorimetric procedures are used for detecting immune complexes on the membrane, color determination may be subjective such that results may be interpreted differently by different observers.

It would be advantageous to provide a method identifying proteins capable of distinguishing an individual and methods for efficiently and accurately determining identity, distinguishing between individuals, as well as determining the source of biological fluids, especially those amenable to automation.

It must be noted that, as used in this specification and the appended claims, the singular forms “a,” “an,” and “the” include plural referents unless the context clearly dictates otherwise. Thus, for example, reference to a method for analyzing a biological sample from “an animal” includes reference to two or more of such animals, reference to “a support” includes reference to one or more of such supports, and reference to “an array” includes reference to two or more of such arrays.

As used herein, “blood” means and includes whole blood, plasma, serum, or any derivative of blood. A blood sample may be, for example, serum.

As used herein, “comprising,” “including,” “containing,” “characterized by,” and grammatical equivalents thereof are inclusive or open-ended terms that do not exclude additional, unrecited elements or method acts. “Comprising” is to be interpreted as including the more restrictive terms “consisting of” and “consisting essentially of”

As used herein, “consisting of” and grammatical equivalents thereof exclude any element, step, or ingredient not specified in the claim.

As used herein, “consisting essentially of” and grammatical equivalents thereof limit the scope of a claim to the specified materials or acts and those that do not materially affect the basic and novel characteristic or characteristics of the claimed invention.

As used herein, the terms “biological sample” and “sample” mean and include a sample comprising individual-specific antibodies obtained from an organism or from components (e.g., cells) of an organism. The sample may be of any biological material. Such samples include, but are not limited to, blood, blood fractions (e.g., serum, plasma), blood cells (e.g., white cells), tissue or fine needle biopsy samples, urine, saliva, perspiration or semen. Biological samples may also include sections of tissues such as frozen sections taken for histological purposes.

As used herein, “color marker” refers to a substrate that produces a colored product in the visible light spectrum upon digestion with an appropriate enzyme. Such colored markers are distinguished from digestion that may produce fluorescent and luminescent products.

The term “discriminant analysis” means and includes a set of statistical methods used to select features that optimally discriminate between two or more groups. Application of discriminant analysis to a data set allows the user to focus on the most discriminating features for further analysis.

As used herein, the terms “immobilized” or “affixed” mean and include an association between a protein or antigen and a substrate at the molecular level (i.e., through a covalent or non-covalent bond or interaction). For example, a protein may be immobilized to a support by covalent bonding directly to a surface of the support which may or may not be modified to enhance such covalent bonding. Also, the protein may be immobilized to the support by use of a linker molecule between the protein and the support. Proteins may further be immobilized on the support by steric hindrance within a polymerized gel or by covalent bonding within a polymerized gel. Proteins may also be immobilized on a support through hybridization between the protein and a molecule immobilized on the support.

The term “protein array” as used herein refers to a protein array, a protein macroarray, a protein microarray or a protein nanoarray. A protein array may include, for example, but is not limited to, ProtoArray™ high density protein array, which is commercially available from Invitrogen (Carlsbad, Calif.). The ProtoArray™ high density protein array may be used to screen complex biological mixtures, such as serum, to assay for the presence of autoantibodies directed against human proteins. Alternatively, a custom protein array that includes autoantigens, such as those provided herein, for the detection of autoantibody biomarkers, may be used to assay for the presence of autoantibodies directed against human proteins. In certain disease states including autoimmune diseases and cancer, autoantibodies are expressed at altered levels relative to those observed in healthy individuals.

As used herein, “support” means a generally or substantially planar substrate onto which an array of antigens is disposed. A support may comprise any material or combination of materials suitable for carrying the array. Materials used to construct these supports need to meet several requirements, such as (1) the presence of surface groups that may be easily derivatized, (2) inertness to reagents used in the assay, (3) stability over time, and (4) compatibility with biological samples. For example, suitable materials include glass, silicon, silicon dioxide (i.e., silica), plastics, polymers, hydrophilic inorganic supports, and ceramic materials. Illustrative plastics and polymers include poly(tetrafluoroethylene), poly(vinylidenedifluoride), polystyrene, polycarbonate, polymethacrylate, and combinations thereof. Illustrative hydrophilic inorganic supports include alumina, zirconia, titania, and nickel oxide. An example of a glass substrate would be a microscope slide. Silicon wafers used to make computer chips have also been used to make biochips. See, for example, U.S. Pat. No. 5,605,662. The supports may further include a coating, such as, nitrocellulose, gelatin, a polymer (i.e., polyvinyl difluoride) or an aldehyde.

As used herein, a “complex” refers to the binding of one molecule to another through a non-covalent interaction, such as the binding of an antibody to an antigen.

In some embodiments, a method of determining proteins useful in discriminating one individual from 1 or more other individuals and/or positively identifying an individual is provided. Such proteins may be referred to herein as “discriminant proteins.” The method may employ a protein array including a plurality of proteins immobilized on a support. As a non-limiting example, the protein array may be a ProtoArray™ human protein microarray, which is commercially available from Invitrogen Corporation (Carlsbad, Calif.). The plurality of proteins immobilized on the support may include a plurality of antigens.

In a typical assay, a plurality of biological samples including individual-specific antibodies may each be physically contacted with a protein array, under conditions that permit high affinity binding, but that minimize non-specific interactions. In one embodiment, the biological samples are introduced to the protein array that includes a plurality of antigens immobilized in predetermined locations on a support. The protein array may be washed free of unbound material, and the presence of bound antibodies may be detected, and correlated with the cognate antigen.

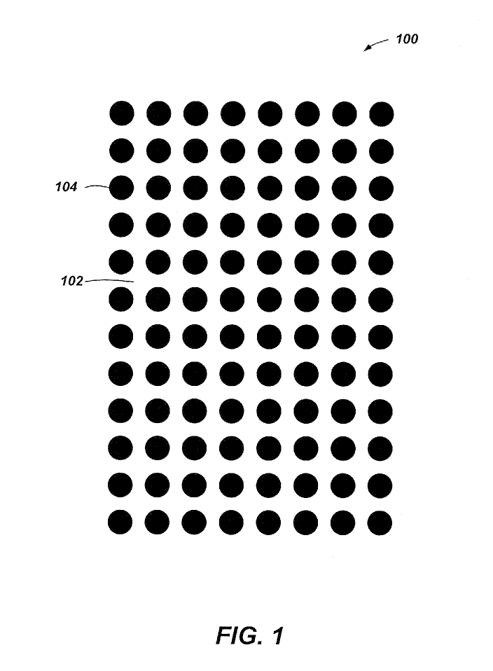

The data collected from each of the plurality of biological samples profiled on a protein array may be used to determine an antibody profile for the individual. The antibody profiles may be analyzed using, for example, conventional discriminant analysis methods, to determine proteins relevant in discriminating and positively identifying an individual (i.e., discriminant proteins) from a population of one or more other individuals. The discriminant proteins may be used to generate a test panel for identifying an individual or determining a source of a biological sample. In some embodiments, the test panel may be, for example, a protein array 100, as shown in FIG. 1, including a plurality of the discriminant proteins arranged as spots 102 in predetermined locations on a support 104.

### Protein Array

The protein array may be prepared by attaching the antigens to the surface of the support in a preselected pattern such that the locations of antigens in the array are known. As used herein, an antigen is a substance that is bound by an antibody. Antigens may include proteins, carbohydrates, nucleic acids, hormones, drugs, receptors, tumor markers, and the like, and mixtures thereof. An antigen may also be a group of antigens, such as a particular fraction of proteins eluted from a size exclusion chromatography column. Still further, an antigen may also be identified as a designated clone from an expression library or a random epitope library.

In one embodiment, antigens may be isolated from HeLa cells as generally described in A. M. Francoeur et al., Identification of Ki (Ku, p 70/p 80) Autoantigens and Analysis of Anti-Ki Autoantibody Reactivity, 136 J. Immunol. 1648 (1986). Briefly, HeLa cells may be grown in standard medium under standard tissue culture conditions. Confluent HeLa cell cultures may then be rinsed, preferably with phosphate-buffered saline (PBS), lysed with detergent, and centrifuged to remove insoluble cellular debris. The supernate contains approximately 10,000 immunologically distinct antigens suitable for generating an array.

There is no requirement that the antigens used to generate the array be known. All that is required is that the source of the antigens be consistent such that a reproducible array may be generated. For example, the HeLa cell supernate containing the antigens may be fractionated on a size exclusion column, electrophoretic gel, density gradient, or the like, as is well known in the art. Fractions may be collected, and each fraction collected could represent a unique set of antigens for the purpose of generating the array. Thus, even though the antigens may be unknown, a reproducible array may be generated if the HeLa cell antigens may be isolated and fractionated using the same method and conditions.

Other methods, such as preparation of random peptide libraries or epitope libraries are well known in the art and may be used to reproducibly produce antigens (e.g., J. K. Scott and G. P. Smith, Searching for Peptide Ligands with an Epitope Library, 249 Science 386 (1990); J. J. Devlin et al., Random Peptide Libraries: A Source of Specific Protein Binding Molecules, 249 Science 404-406 (1990); S. E. Cwirla et al., Peptides on Phage: A Vast Library of Peptides for Identifying Ligands, 87 Proc. Nat'l Acad. Sci. USA 6378-6382 (1990); K. S. Lam et al., A New Type of Synthetic Peptide Library for Identifying Ligand-binding Activity, 354 Nature 82-84 (1991); S. Cabilly, Combinatorial Peptide Library Protocols, Humana Press, 304 p.p., 129-154 1997; and U.S. Pat. No. 5,885,780). Such libraries may be constructed by ligating synthetic oligonucleotides into an appropriate fusion phage. Fusion phages may be filamentous bacteriophage vectors in which foreign sequences may be cloned into phage gene III and displayed as part of the gene III protein (pIII) at one tip of the virion. Each phage encodes a single random sequence and expresses it as a fusion complex with pIII, a minor coat protein present at about five molecules per phage. For example, in the fusion phage techniques of J. K. Scott and G. P. Smith, supra, a library was constructed of phage containing a variable cassette of six amino acid residues. The hexapeptide modules fused to bacteriophage proteins provided a library for the screening methodology that may examine>10¹² phages (or about 10⁸-10¹⁰ different clones) at one time, each with a test sequence on the virion surface. The library obtained was used to screen monoclonal antibodies specific for particular hexapeptide sequences. The fusion phage system has also been used by other groups, and libraries containing longer peptide inserts have been constructed. Fusion phage prepared according to this methodology may be selected randomly or non-randomly for inclusion in the array of antigens. The fusion phages selected for inclusion in the array may be propagated by standard methods to result in what is virtually an endless supply of the selected antigens.

Other methods for producing antigens are also known in the art. For example, expression libraries may be prepared by random cloning of DNA fragments or cDNA into an expression vector (e.g., R. A. Young and R. W. Davis, Yeast RNA Polymerase II Genes: Isolation with Antibody Probes, 222 Science 778-782 (1983); G. M. Santangelo et al., Cloning of Open Reading Frames and Promoters from the Saccharomyces cerevisiae Genome: Construction of Genomic Libraries of Random Small Fragments, 46 Gene 181-186 (1986). Expression vectors that could be used for making such libraries are commercially available from a variety of sources. For example, random fragments of HeLa cell DNA or cDNA may be cloned into an expression vector, and then clones expressing HeLa cell proteins may be selected. These clones may then be propagated by methods well known in the art. The expressed proteins may then be isolated or purified and may be used in the making of the array.

Alternatively, antigens may be synthesized using recombinant DNA technology well known in the art. Genes that code for many proteins from a gamut of organisms including viruses, bacteria, and mammals have been cloned, and thus large quantities of highly pure proteins may be synthesized quickly and inexpensively. For example, the genes that code for many eukaryotic and mammalian membrane-bound receptors, growth factors, cell adhesion molecules, and regulatory proteins have been cloned and may be useful as antigens. Many proteins produced by such recombinant techniques, such as transforming growth factor, acidic and basic fibroblast growth factors, interferon, insulin-like growth factor, and various interleukins from different species, are commercially available. In most instances, the entire polypeptide need not be used as an antigen. For example, any size or portion of the polypeptide that contains at least one epitope, i.e., antigenic determinant or portion of an antigen that specifically interacts with an antibody, will suffice for use in the array. In addition, a particular antigen may be purified or isolated from any natural or synthetic source of the antigen by methods known in the art.

The antigens, whether selected randomly or non-randomly, may be disposed on the support to result in the array. The pattern of the antigens on the support should be reproducible. In embodiments, the location and identity of each antigen on the support may be known. For example, in a 10×10 array one skilled in the art might place antigens 1-100 in locations 1-100, respectively, of the array. As a non-limiting example, each of the antigens of the array may be deposited on the support as a spot having a diameter of from about 10 microns to about 500 microns and, more particularly, from about 50 microns to about 300 microns.

The proteins may placed in arrays on the surface of the support using a pipetting device or a machine or device configured for placing liquid samples on a support, for example, using a commercially available microarrayer, such as those from Arrayit Corporation (Sunnyvale, Calif.); Genomic Solutions, Inc. (Ann Arbor, Mich.); Gene Machines (San Carlos, Calif.); Genetic MicroSystems, Inc. (Woburn, Mass.); GenePack DNA (Cambridge, UK); Genetix Ltd. (Christchurch, Dorset, UK); and Packard Instrument Company (Meriden, Conn.).

Relevant methods to array a series of proteins onto a surface include contact printing processes, non-contact printing processes and in silico protein synthesis arrayer processes. Commercially available instruments are available for both methods. In some embodiments, conventional contact printing processes, such as contact pin printing and microstamping, in which the printing device may physically contact a surface may be used to apply the proteins to the surface of a support. For example, a pin printing device such as that commercially available from Arrayit Corporation may be used to deposit spots having an average diameter of 65 microns or larger. As another non-limiting example, Genomic Solutions offers several nanoliter dispensing instruments that may dispense liquid volumes from 20 mL up to 250 μL from 96-, 384-, 1536-, 3456-, and 9600-well microtiter plates and place them precisely on a surface with densities up to 400 spots/cm². The instruments will spot onto surfaces in a variety of patterns. In additional embodiments, the protein antigens may be applied to the surface without physical contact between the printing device and the surface using conventional non-contact printing processes including, but not limited to, photochemistry-based methods, laser writing, electrospray deposition, and inkjet. As the name implies, inkjet technology utilizes the same principles as those used in inkjet printers. MicroFab Technologies, Inc. (Plano, Tex.), offers a ten-fluid print head that may dispense picoliter quantities of liquids onto a surface in a variety of patterns. An illustrative pattern for the present application would be a simple array ranging from 10×10 up to 100×100. The protein antigens may be applied to the surface using a serial deposition process or a parallel deposition process.

There are a number of methods that may be used to attach proteins or other antigens to the surface of a support. The simplest of these is simple adsorption through hydrophobic, ionic, and van der Waals forces. As a non-limiting example, bifunctional organosilanes may be used in attachment of proteins to the surface of the support (e.g., Thompson and Maragos, Fiber-Optic Immunosensor for the Detection of Fumonisin B₁, 44 J. Agric. Food Chem. 1041-1046 (1996)). One end of the organosilane reacts with exposed —OH groups on the surface of the support to form a silanol bond. The other end of the organosilane contains a group that is reactive with various groups on the protein surface, such as —NH₂ and —SH groups. This method of attaching proteins to the support results in the formation of a covalent linkage between the protein and the support. Other suitable methods that have been used for protein attachment to surfaces include arylazide, nitrobenzyl, and diazirine photochemistry methodologies. Exposure of the above chemicals to UV light causes the formation of reactive groups that may react with proteins to form a covalent bond. The arylazide chemistry forms a reactive nitrene group that may insert into C—H bonds, while the diazirine chemistry results in a reactive carbene group. The nitrobenzyl chemistry is referred to as caging chemistry whereby the caging group inactivates a reactive molecule. Exposure to UV light frees the molecule and makes it available for reaction. Still other methods for attaching proteins to supports are well known in the art, (e.g., S. S. Wong, Chemistry of Protein Conjugation and Cross-Linking CRC Press, 340, 1991).

Following attachment of the antigens on the support in the selected array, the support may be washed. The wash solution may include, for example, one or more of a surfactant or a non-specific protein such as bovine serum albumin (BSA). Appropriate liquids for washing include, but are not limited to, phosphate buffered saline (PBS) and the like, i.e., relatively low ionic strength, biocompatible salt solutions buffered at or near neutrality. Many of such appropriate wash liquids are known in the art or may be devised by a person skilled in the art without undue experimentation (e.g., N. E. Good and S. Izawa, Hydrogen Ion Buffers, 24 Methods Enzymology 53-68 (1972)).

The support may be processed for blocking of nonspecific binding of proteins and other molecules to the support. This blocking step may prevent the binding of antigens, antibodies, and the like to the support wherein such antigens, antibodies, or other molecules are not intended to bind. Blocking may reduce the background that might swamp out the signal, thus increasing the signal-to-noise ratio. The support may be blocked by incubating the support in a medium that contains inert molecules that bind to sites where nonspecific binding might otherwise occur. Examples of suitable blockers include, but are not limited to, bovine serum albumin, human albumin, gelatin, nonfat dry milk, polyvinyl alcohol, TWEEN® 20, and various commercial blocking buffers, such as SEABLOCK™ blocking buffer from EastCoast Bio, Inc., (West Berwick, Me.) and SUPERBLOCK® blocking buffer from Pierce Chemical Co., (Rockford, Ill.). In some embodiments, one or more of the suitable blockers may be incorporated into the wash solution described above.

### Antibody Profile

The array may be contacted with a sample of the biological material to be tested. For example, the biological sample may be obtained from various bodily fluids and solids, including blood, saliva, semen, serum, plasma, urine, amniotic fluid, pleural fluid, cerebrospinal fluid, and mixtures thereof. These samples may be obtained according to methods well known in the art. Depending on the detection method used, it may be required to manipulate the biological sample to attain optimal reaction conditions. For example, the ionic strength or hydrogen ion concentration or the concentration of the biological sample may be adjusted for optimal immune complex formation, enzymatic catalysis, and the like.

As described in detail in U.S. Pat. No. 5,270,167 to Francoeur, when ISAs are allowed to react with a set of random antigens, a certain number of immune complexes form. For example, using a panel of about 1000 unique antigens, about 30 immune complexes between ISAs in a biological sample that has been diluted 20-fold may be detected. If the biological sample is undiluted, the total number of possible detectable immune complexes that could form would be greater than 10²³. The total number of possible immune complexes may also be increased by selecting “larger” antigens, i.e., proteins instead of peptides) that have multiple epitopes. Therefore, it will be appreciated that depending on the antigens and number thereof used, the dilution of the biological sample, and the detection method, one skilled in the art may regulate the number of immune complexes that will form and be detected. As used herein, an “antibody profile” refers to the set of unique immune complexes that form and fail to form between the ISAs in the biological sample and the antigens in the array.

Detection and/or Quantification of Reactions

Methods for detecting antibody/antigen or immune complexes are well known in the art. The present disclosure may be modified by one skilled in the art to accommodate the various detection methods known in the art. The particular detection method chosen by one skilled in the art depends on several factors, including the amount of biological sample available, the type of biological sample, the stability of the biological sample, the stability of the antigen, and the affinity between the antibody and antigen. Moreover, as discussed above, depending on the detection methods chosen, it may be required to modify the biological sample. While these techniques are well known in the art, non-limiting examples of a few of the detection methods that may be used to practice the present disclosure are briefly described below.

There are many types of immunoassays known in the art. The most common types of immunoassay are competitive and non-competitive heterogeneous assays, such as, for example, enzyme-linked immunosorbent assays (ELISAs). In a non-competitive ELISA, unlabeled antigen is bound to a support. A biological sample may be combined with antigens bound to the reaction vessel, and antibodies (primary antibodies) in the biological sample may be allowed to bind to the antigens, forming the immune complexes. After the immune complexes have formed, excess biological sample may be removed and the array may be washed to remove nonspecifically bound antibodies. The immune complexes may then be reacted with an appropriate enzyme-labeled anti-immunoglobulin (secondary antibody). The secondary antibody reacts with antibodies in the immune complexes, not with other antigens bound to the array. Secondary antibodies specific for binding antibodies of different species, including humans, are well known in the art and are commercially available, such as from Sigma Chemical Co. (St. Louis, Mo.) and Santa Cruz Biotechnology, Inc. (Santa Cruz, Calif.). After an optional further wash, the enzyme substrate may be added. The enzyme linked to the secondary antibody catalyzes a reaction that converts the substrate into a product. When excess antigen is present, the amount of product is directly proportional to the amount of primary antibody present in the biological sample. By way of non-limiting example, the product may be fluorescent or luminescent, which may be measured using technology and equipment well known in the art. It is also possible to use reaction schemes that result in a colored product, which may be measured spectrophotometrically.

In other embodiments of the disclosure, the secondary antibody may not be labeled to facilitate detection. Additional antibodies may be layered (i.e., tertiary, quaternary, etc.) such that each additional antibody specifically recognizes the antibody previously added to the immune complex. Any one of these additional (i.e., tertiary, quaternary, etc.) may be labeled so as to allow detection of the immune complex as described herein.

Sandwich or capture assays may also be used to identify and quantify immune complexes. Sandwich assays are a mirror image of non-competitive ELISAs in that antibodies are bound to the solid phase and antigen in the biological sample is measured. These assays may be particularly useful in detecting antigens having multiple epitopes that are present at low concentrations. This technique requires excess antibody to be attached to a solid phase. The bound antibody is then incubated with the biological samples, and the antigens in the sample may be allowed to form immune complexes with the bound antibody. The immune complex is incubated with an enzyme-linked secondary antibody, which recognizes the same or a different epitope on the antigen as the primary antibody. Hence, enzyme activity is directly proportional to the amount of antigen in the biological sample. D. M. Kemeny and S. J. Challacombe, ELISA and Other Solid Phase Immunoassays, (John Wiley & Sons Ltd.) (1988).

Typical enzymes that may be linked to secondary antibodies include, but are not limited to, horseradish peroxidase, glucose oxidase, glucose-6-phosphate dehydrogenase, alkaline phosphatase, β-galactosidase, and urease. Secondary antigen-specific antibodies linked to various enzymes are commercially available from, for example, Sigma Chemical Co. and Amersham Life Sciences (Arlington Heights, Ill.).

Competitive ELISAs are similar to noncompetitive ELISAs except that enzyme linked antibodies compete with unlabeled antibodies in the biological sample for limited antigen binding sites. Briefly, a limited number of antigens may be bound to the support. Biological sample and enzyme-labeled antibodies may be added to the support. Antigen-specific antibodies in the biological sample compete with enzyme-labeled antibodies for the limited number of antigens bound to the support. After immune complexes have formed, nonspecifically bound antibodies may be removed by washing, enzyme substrate is added, and the enzyme activity is measured. No secondary antibody is required. Because the assay is competitive, enzyme activity is inversely proportional to the amount of antibodies in the biological sample.

Another competitive ELISA may also be used within the scope of the present disclosure. In this embodiment, limited amounts of antibodies from the biological sample may be bound to the surface of the support as described herein. Labeled and unlabeled antigens may be then brought into contact with the support such that the labeled and unlabeled antigens compete with each other for binding to the antibodies on the surface of the support. After immune complexes have formed, nonspecifically bound antigens may be removed by washing. The immune complexes may be detected by incubation with an enzyme-linked secondary antibody, which recognizes the same or a different epitope on the antigen as the primary antibody, as described above. The activity of the enzyme is then assayed, which yields a signal that is inversely proportional to the amount of antigen present.

Homogeneous immunoassays may also be used when practicing the method of the present disclosure. Homogeneous immunoassays may be preferred for detection of low molecular weight compounds, such as hormones, therapeutic drugs, and illegal drugs that cannot be analyzed by other methods or compounds found in high concentration. Homogeneous assays may be particularly useful because no separation step is necessary. R. C. Boguslaski et al., Clinical Immunochemistry: Principles of Methods and Applications, (1984).

In homogeneous techniques, bound or unbound antigens may be enzyme-linked. When antibodies in the biological sample bind to the enzyme-linked antigen, steric hindrances inactivate the enzyme. This results in a measurable loss in enzyme activity. Free antigens (i.e., not enzyme-linked) compete with the enzyme-linked antigen for limited antibody binding sites. Thus, enzyme activity is directly proportional to the concentration of antigen in the biological sample.

Enzymes useful in homogeneous immunoassays include, but are not limited to, lysozyme, neuraminidase, trypsin, papain, bromelain, glucose-6-phosphate dehydrogenase, and β-galactosidase. T. Persoon, “Immunochemical Assays in the Clinical Laboratory,” 5 Clinical Laboratory Science 31 (1992). Enzyme-linked antigens are commercially available or may be linked using various chemicals well known in the art, including glutaraldehyde and maleimide derivatives.

Prior antibody profiling technology involved an alkaline phosphatase labeled secondary antibody with 5-bromo-4-chloro-3′-indolylphosphate p-toluidine salt (BCIP) and nitro-blue tetrazolium chloride (NBT), both of which are commercially available from a variety of sources, such as from Pierce Chemical Co. (Rockford, Ill.). The enzymatic reaction forms an insoluble colored product that is deposited on the surface of membrane strips to form bands wherever antigen-antibody complexes occur. As a non-limiting example, the array may be scanned to detect a colored product using one of a variety of conventional desktop scanners, which are commercially available from a variety of sources, such as from Canon U.S.A. (Lake Success, N.Y.). The intensity of the colored product may be quantified by calculating the median feature pixel intensity minus median background pixel intensity.

As another non-limiting example, gold nanoparticle labeled antibodies may be employed and may be detected using a scanning, transmission electron microscopy, and/or dark-field zoom stereomicroscopy. Compared to conventional fluorescent labels, the gold nanoparticles scatter incident white light to generate monochromatic light which may be easily detected. The light intensity generated by the gold nanoparticles may be up to 100,000 times greater than that generated by fluorescent-labeled molecules. For example, the gold nanoparticles may be detected using a conventional desktop scanner. Han et al., Detection of Analyte Binding to Microarrays Using Gold Nanoparticle Labels and a Desktop Scanner, 3 Lab Chip 329; 329-332 (2003).

Fluorescent immunoassays may also be used when practicing the method of the present disclosure. Fluorescent immunoassays are similar to ELISAs except the enzyme is substituted for fluorescent compounds called fluorophores or fluorochromes. These compounds have the ability to absorb energy from incident light and emit the energy as light of a longer wavelength and lower energy. Fluorescein and rhodamine, usually in the form of isothiocyanates that may be readily coupled to antigens and antibodies, are most commonly used in the art. D. P. Stites et al., Basic and Clinical Immunology, (1994). Fluorescein absorbs light of 490 to 495 nm in wavelength and emits light at 520 nm in wavelength. Tetramethylrhodamine absorbs light of 550 nm in wavelength and emits light at 580 nm in wavelength. Illustrative fluorescence-based detection methods include ELF-97 alkaline phosphatase substrate (Molecular Probes, Inc., Eugene, Oreg.); PBXL-1 and PBXL-3 (phycobilisomes conjugated to streptavidin) (Martek Biosciences Corp., Columbia, Md.); FITC (fluorescein isothiocyanate) and Texas Red labeled goat anti-human IgG (Jackson ImmunoResearch Laboratories, Inc., West Grove, Pa.); and B-Phycoerythrin and R-Phycoerythrin conjugated to streptavidin (Molecular Probes Inc.). ELF-97 is a nonfluorescent chemical that is digested by alkaline phosphatase to form a fluorescent molecule. Because of turnover of the alkaline phosphatase, use of the ELF-97 substrate results in signal amplification. Fluorescent molecules attached to secondary antibodies do not exhibit this amplification.

Phycobiliproteins isolated from algae, porphyrins, and chlorophylls, which all fluoresce at about 600 nm, are also being used in the art. I. Hemmila, Fluoroimmunoassays and Immunofluorometric Assays, 31 Clin. Chem. 359 (1985); U.S. Pat. No. 4,542,104. Phycobiliproteins and derivatives thereof are commercially available under the names R-phycoerythrin (PE) and QUANTUM RED™ from Sigma Chemical Co.

In addition, Cy-conjugated secondary antibodies and antigens may be useful in immunoassays and are commercially available. Cy3, for example, is maximally excited at 554 nm and emits light at between 568 and 574 nm. Cy3 is more hydrophilic than other fluorophores and thus has less of a tendency to bind nonspecifically or aggregate. Cy-conjugated compounds are commercially available from Amersham Life Sciences.

Illustrative luminescence-based detection methods include CSPD® and CDP star alkaline phosphatase substrates from Roche Molecular Biochemicals, (Indianapolis, Ind.) and SUPERSIGNAL® horseradish peroxidase substrate from Pierce Chemical Co., (Rockford, Ill.).

Chemiluminescence, electroluminescence, and electrochemiluminescence (ECL) detection methods may also be attractive means for quantifying antigens and antibodies in a biological sample. Luminescent compounds have the ability to absorb energy, which is released in the form of visible light upon excitation. In chemiluminescence, the excitation source is a chemical reaction; in electroluminescence the excitation source is an electric field; and in ECL an electric field induces a luminescent chemical reaction.

Molecules used with ECL detection methods generally comprise an organic ligand and a transition metal. The organic ligand forms a chelate with one or more transition metal atoms forming an organometallic complex. Various organometallic and transition metal-organic ligand complexes have been used as ECL labels for detecting and quantifying analytes in biological samples. Due to their thermal, chemical, and photochemical stability, their intense emissions and long emission lifetimes, ruthenium, osmium, rhenium, iridium, and rhodium transition metals are favored in the art. The types of organic ligands are numerous and include anthracene and polypyridyl molecules and heterocyclic organic compounds. For example, bipyridyl, bipyrazyl, terpyridyl, and phenanthrolyl, and derivatives thereof, are common organic ligands in the art. A common organometallic complex used in the art includes tris-bipyridine ruthenium (II), commercially available from IGEN, Inc. (Rockville, Md.) and Sigma Chemical Co.

ECL may be performed under aqueous conditions and under physiological pH, thus minimizing biological sample handling. J. K. Leland et al., Electrogenerated Chemiluminescence: An Oxidative-Reduction Type ECL Reactions Sequence Using Triprophyl Amine, 137 J. Electrochemical Soc. 3127-3131 (1990); WO 90/05296; and U.S. Pat. No. 5,541,113. Moreover, the luminescence of these compounds may be enhanced by the addition of various cofactors, such as amines.

A tris-bipyridine ruthenium (II) complex, for example, may be attached to a secondary antibody using strategies well known in the art, including attachment to lysine amino groups, cysteine sulfhydryl groups, and histidine imidazole groups. In a typical ELISA immunoassay, secondary antibodies would recognize antibodies bound to antigens, but not unbound antigens. After washing nonspecific binding complexes, the tris-bipyridine ruthenium (II) complex may be excited by chemical, photochemical, and electrochemical excitation means, such as by applying current to the array (e.g., WO 86/02734). The excitation would result in a double oxidation reaction of the tris-bipyridine ruthenium (II) complex, resulting in luminescence that could be detected by, for example, a photomultiplier tube. Instruments for detecting luminescence are well known in the art and are commercially available, for example, from IGEN, Inc. (Rockville, Md.).

Solid state color detection circuitry may also be used to monitor the color reactions on the array and, on command, compare the color patterns before and after the sample application. A color camera image may also be used and the pixel information analyzed to obtain the same information.

Still another method involves detection using a surface plasmon resonance (SPR) chip. The surface of the chip is scanned before and after sample application and a comparison is made. The SPR chip relies on the refraction of light when the molecules of interest may be exposed to a light source. Each molecule has its own refraction index by which it may be identified. This method requires precise positioning and control circuitry to scan the chip accurately.

Yet another method involves a fluid rinse of the array with a fluorescing reagent. The antigens that combine with the biological sample will fluoresce and may be detected with a charge-coupled device (CCD) array. The output of such a CCD array is analyzed to determine the unique pattern associated with each sample. Speed is not a factor with any of the methods since the chemical combining of sample and reference takes minutes to occur.

Moreover, array scanners are commercially available, such as from Genetic MicroSystems, Inc. The GMS 418 Array Scanner uses laser optics to rapidly move a focused beam of light over the array. This system uses a dual-wavelength system including high-powered, solid-state lasers that generate high excitation energy to allow for reduced excitation time. At a scanning speed of 30 Hz, the GMS 418 may scan a 22×75-mm slide with 10-μm resolution in about four minutes.

Software for image analysis obtained with an array scanner is readily available. Available software packages include ImaGene (BioDiscovery, Los Angeles, Calif.); ScanAlyze (available at no charge; developed by Mike Eisen, Stanford University, Palo Alto, Calif.); De-Array (developed by Yidong Chen and Jeff Trent of the National Institutes of Health; used with IP Lab from Scanalytics, Inc., Fairfax, Va.); Pathways (Research Genetics, Huntsville, Ala.); GEM Tools (Incyte Pharmaceuticals, Inc., Palo Alto, Calif.); and Imaging Research (Amersham Pharmacia Biotech, Inc., Piscataway, N.J.).

Once interactions between the antigens and antibodies have been identified and quantified, the signals may be digitized. The digitized antibody profile may serve as a signature that identifies the source of the biological sample. Depending on the array used, the digitized data may take numerous forms. For example, the array may include 10 columns and 10 rows for a total number of 100 spots, each including at least one antigen. After the biological sample including the antibodies is added to the array and allowed to incubate, interactions between antigens and antibodies in the biological sample may be identified and quantified. In each spot, an interaction between the antigen in the spot and the antibody in the biological sample will either result in or not result in a quantifiable signal. In one embodiment, the results of the antibody profile may be digitized by, by way of non limiting example, ascribing each one of the 100 spots a numerical value of either “0,” if a quantifiable signal was not obtained, or “1,” if a quantifiable signal was obtained. Using this method, the digitized antibody profile may comprise a unique set of zeroes and ones. It will be understood that the use of 1 and 0 is merely exemplary and that any set of values or indicators may be used to signify the absence, presence, or intensity of a particular signal.

The numerical values “0” or “1” may, of course, be normalized to signals obtained in internal control spots so that digitized antibody profiles obtained at a later time may be properly compared. For example, one or several of the spots may contain a known antigen, which will remain constant over time. Therefore, if a subsequent biological sample is more or less dilute than a previous biological sample, the signals may be normalized using the signals from the known antigen.

It will be appreciated by one skilled in the art that other methods of digitizing the antibody profile exist and may be used. For example, rather than ascribing each spot with a numerical value of “0” or “1,” the numerical value may be incremental and directly proportional to the strength of the signal.

### Statistical Analysis

The antibody profiles obtained from the plurality of individuals may be analyzed using conventional discriminant analysis methods to determine proteins useful in discriminating or identifying an individual from one or more other individuals. For example, discriminant proteins may be determined using forward selection, backward elimination, or stepwise selection to determine a subset of proteins that best reveals differences among the classes (i.e., the individuals). The STEPDISC procedure, which is available from SAS Institute, Inc. (Cary, N.C.), may be used to perform a stepwise discriminant analysis to select a subset of the proteins useful in discriminating among individuals. Signals from a set of proteins that make up each class may be assumed to be multivariate normal with a common covariance matrix.

Using the STEPDISC procedure, variables (in particular, signals from particular proteins) may be chosen to enter or leave the model according to the significance level of an F-test from an analysis of covariance, where the variables already chosen act as covariates and the variable under consideration is the dependent variable. In other embodiments, a variable could be chosen to enter or leave the model according to whether the squared partial correlation for its prediction using the class variable (and controlling for the effects of the other variables already in the model) is high.

In some embodiments, the discriminant proteins useful in discriminating or identifying an individual may be determined by calculating various discriminant functions for classifying observations using the protein signals. Linear or quadratic discriminant functions may be used for data with approximately multivariate normal within-class distributions. Nonparametric methods may be used without making any assumptions about these distributions.

One or more of the discriminant proteins may be used to identify an individual, to distinguish between individuals, or to establish or rule out the source of a biological sample. In some embodiments, one or more of the discriminant proteins may be used as part of a test panel. For example, discriminant proteins may be immobilized on a support in the form of an array as described above to form a protein array useful in discriminating among individuals and/or sources of a biological sample. However, other methods of detecting an interaction between a discriminant protein and an antibody present in a biological sample, such as conventional protein affinity chromatography methods, affinity blotting methods, immunoprecipitation methods, and cross-linking methods, may also be used. In embodiments, the array or test panel may be used to generate an antibody profile which may be used to distinguish between individuals in a population, or to establish or rule out the source of a biological sample within a population, wherein the population may comprise 1 million, 10 million, 100 million, 1 billion, 10 billion, 100 billion, or more individuals.

The array may include several discriminant proteins, each of which may be immobilized on a support. The array may include less than about 200, 175, 170, 150, 125, 110, 100, 75, or 50 discriminant proteins. For example, the test panel for discriminating or identifying an individual may include from about 20 to about 90 discriminant proteins, and more particularly, from about 45 to about 80 discriminant proteins, less than about 100 discriminant proteins, less than about 110 discriminant proteins, or less than about 170 discriminant proteins. With “X” different profiles that are each independent, the probability that no two different people have the same profile among “m” people can be shown to be equal to exp[−m*m/(2×)]. As a non-limiting example, greater than about 76 independent discriminant proteins may be used to distinguish an individual among a population of about 10 billion individuals, the probability of a match between two different individuals being less than about 0.0001. As another non-limiting example, greater than about 86 independent discriminant proteins may be used to distinguish an individual among a population of about 100 billion individuals, the probability of a match between two different individuals being less than about 0.0001. Examples of discriminant proteins include, but are not limited to, those proteins presented in Table 1.

TABLE 1

| SEQ ID NO | Protein ID |
|---|---|
| SEQ ID NO: 1 | PM_2149 |
| SEQ ID NO: 2 | PM_2151 |
| SEQ ID NO: 3 | BC010125.1 |
| SEQ ID NO: 4 | BC011414.1 |
| SEQ ID NO: 5 | BC012945.1 |
| SEQ ID NO: 6 | BC014409.1 |
| SEQ ID NO: 7 | BC015219.1 |
| SEQ ID NO: 8 | BC016470.2 |
| SEQ ID NO: 9 | BC018206.1 |
| SEQ ID NO: 10 | BC018404.1 |
| SEQ ID NO: 11 | BC019039.2 |
| SEQ ID NO: 12 | BC019315.1 |
| SEQ ID NO: 13 | BC021189.2 |
| SEQ ID NO: 14 | BC023152.1 |
| SEQ ID NO: 15 | BC026175.1 |
| SEQ ID NO: 16 | BC026346.1 |
| SEQ ID NO: 17 | BC032825.2 |
| SEQ ID NO: 18 | BC033711.1 |
| SEQ ID NO: 19 | BC036123.1 |
| SEQ ID NO: 20 | BC040949.1 |
| SEQ ID NO: 21 | BC050377.1 |
| SEQ ID NO: 22 | BC052805.1 |
| SEQ ID NO: 23 | BC053602.1 |
| SEQ ID NO: 24 | BC060824.1 |
| SEQ ID NO: 25 | NM_015138.2 |
| SEQ ID NO: 26 | NM_175887.2 |
| SEQ ID NO: 27 | NM_000394.2 |
| SEQ ID NO: 28 | NM_000723.3 |
| SEQ ID NO: 29 | NM_001008220.1 |
| SEQ ID NO: 30 | NM_001106.2 |
| SEQ ID NO: 31 | NM_001312.2 |
| SEQ ID NO: 32 | NM_001537.1 |
| SEQ ID NO: 33 | NM_002737 |
| SEQ ID NO: 34 | NM_002740 |
| SEQ ID NO: 35 | NM_002744 |
| SEQ ID NO: 36 | NM_003907.1 |
| SEQ ID NO: 37 | NM_003910.2 |
| SEQ ID NO: 38 | NM_004064.2 |
| SEQ ID NO: 39 | NM_004394.1 |
| SEQ ID NO: 40 | NM_004845.3 |
| SEQ ID NO: 41 | NM_004965.3 |
| SEQ ID NO: 42 | NM_005030 |
| SEQ ID NO: 43 | NM_005246.1 |
| SEQ ID NO: 44 | NM_006007.1 |
| SEQ ID NO: 45 | NM_006218.2 |
| SEQ ID NO: 46 | NM_006628.4 |
| SEQ ID NO: 47 | NM_006819.1 |
| SEQ ID NO: 48 | NM_012472.1 |
| SEQ ID NO: 49 | NM_014240.1 |
| SEQ ID NO: 50 | NM_014245.1 |
| SEQ ID NO: 51 | NM_014460.2 |
| SEQ ID NO: 52 | NM_014622.4 |
| SEQ ID NO: 53 | NM_014891.1 |
| SEQ ID NO: 54 | NM_014943.3 |
| SEQ ID NO: 55 | NM_015149.2 |
| SEQ ID NO: 56 | NM_015417.2 |
| SEQ ID NO: 57 | NM_015509.2 |
| SEQ ID NO: 58 | NM_016096.1 |
| SEQ ID NO: 59 | NM_016520.1 |
| SEQ ID NO: 60 | NM_017855.2 |
| SEQ ID NO: 61 | NM_017949.1 |
| SEQ ID NO: 62 | NM_018326.1 |
| SEQ ID NO: 63 | NM_018584.4 |
| SEQ ID NO: 64 | NM_024718.2 |
| SEQ ID NO: 65 | NM_024826.1 |
| SEQ ID NO: 66 | NM_025241.1 |
| SEQ ID NO: 67 | NM_032345.1 |
| SEQ ID NO: 68 | NM_032368.3 |
| SEQ ID NO: 69 | NM_079420.1 |
| SEQ ID NO: 70 | NM_080390.3 |
| SEQ ID NO: 71 | NM_138623.2 |
| SEQ ID NO: 72 | NM_145796.2 |
| SEQ ID NO: 73 | NM_153757.1 |
| SEQ ID NO: 74 | NM_177973.1 |
| SEQ ID NO: 75 | NM_178010.1 |
| SEQ ID NO: 76 | NM_199124.1 |
| SEQ ID NO: 77 | NM_201262.1 |
| SEQ ID NO: 78 | NM_203284.1 |
| SEQ ID NO: 79 | NM_205853.1 |
| SEQ ID NO: 80 | NM_212540.1 |

In embodiments of the disclosure, a protein array may comprise 1, 2, 3, 4, 5, 10, 15, 20, 25, 50, or more discriminant proteins selected from the group consisting of SEQ ID NOs: 1-80, SEQ ID NOs: 1-45, SEQ ID NOs: 1-3, 5, 6, 8, 9, 11, 12, 15-18, 22-24, 26, 27, 29, 33, 38, 41, 44, 46-48, 51, 20, 54, 57-60, 62, 65, 68, 70, 72, 72-75, 77, and 79, and SEQ ID NOs: 1-9, 11-13, 15-20, 22-24, 26-30, 33, 35, 36, 38-41, 44, 46-54, 57-60, 62, 63, 66, 68, 70, and 72-80. In embodiments, a protein array may consist of SEQ ID NOs: 1-80, SEQ ID NOs: 1-45, SEQ ID NOs: 1-3, 5, 6, 8, 9, 11, 12, 15-18, 22-24, 26, 27, 29, 33, 38, 41, 44, 46-48, 51, 20, 54, 57-60, 62, 65, 68, 70, 72, 72-75, 77, and 79, and SEQ ID NOs: 1-9, 11-13, 15-20, 22-24, 26-30, 33, 35, 36, 38-41, 44, 46-54, 57-60, 62, 63, 66, 68, 70, and 72-80.

In an embodiment of the disclosure, a protein array including discriminant proteins may be used for forensic analysis for matching a biological sample to an individual such as, for example, a criminal suspect. Forensic samples obtained from crime scenes are often subject to drying of the samples, small sample sizes, mixing with samples from more than one individual, adulteration with chemicals, and the like. The present method provides the advantages of rapid analysis, simplicity, low cost, and accuracy for matching forensic samples with suspects. For example, the forensic sample and a sample from one or more suspects may be obtained according to methods well known in the art. The samples may be tested against the array and compared. If the discriminant proteins obtained from the samples match, it may be concluded that the forensic sample was obtained from the matching suspect. If no match of discriminant proteins is obtained, then none of the suspects was the source of the forensic sample.

### EXAMPLE

Serum samples from ninety-four (94) individuals were profiled against a high throughput protein array with over 8000 proteins and the data from these chips was statistically analyzed to determine proteins useful for discriminating among sets of individuals in a population. The ninety-four (94) individuals included nineteen (19) Asian individuals, twenty (20) African American individuals, twenty (20) Native American individuals, and thirty-five (35) Caucasian individuals. For quality assurance (QA), the arrays contained the immobilized proteins in pairs on a support. Thus, each array provided two opportunities for antigen/antibody binding for each protein.

The serum samples were diluted 1:150 and used to probe human ProtoArray™. The arrays were blocked for 1 hour and then incubated with the serum samples for 90 minutes at about 4° C. without shaking. The arrays were then transferred to ice and washed about three times by adding about 20 ml buffer (1×PBS, 5 mM MgCl2, 0.5 mM DTT, 0.05% Triton X-100, 5% Glycerol, 1% BSA) to the arrays, incubating the arrays with the buffer for 8 minutes at 4° C., and decanting the buffer from the arrays by inverting. The arrays were incubated with anti-human IgG antibody conjugated to AlexaFluor 647 for about 90 minutes, washed as above and dried. The arrays were scanned using a ScanArray Express® 3.0 HT microarray scanner, which is available commercially from Perkin Elmer, Inc. (Waltham, Mass.). The images were captured from the microarray scanner using a 633 nm laser with the scanner set to 10 μm resolution. Following scanning, data was acquired using ImaGene 8.0 microarray analysis software from BioDiscovery (El Segundo, Calif.). Background-subtracted signals from each population were normalized utilizing a quantile normalization strategy. Subjects were distinguished from one another using conventional discriminant analysis. The STEPDISC procedure from SAS Institute, Inc. was utilized to identify discriminant proteins based on the logarithms of the intensities detected. The discriminant proteins of interest were identified as significant in distinguishing between individuals. A list of 80 discriminating proteins from among the over 8,000 on the arrays was determined. The 80 discriminating proteins are listed in Table 2.

TABLE 2

| SEQ ID NO | Protein ID | SelOrdAll | MinPSeeOrNot | sRatio | maxCorrAfter |
|---|---|---|---|---|---|
| SEQ ID NO: 1 | PM_2149 | 16 | 0.45 | 22.1 | 0.683 |
| SEQ ID NO: 2 | PM_2151 | 99 | 0.25 | 13.4 | 0.585 |
| SEQ ID NO: 3 | BC010125.1 | 62 | 0.23 | 15.6 | 0.500 |
| SEQ ID NO: 4 | BC011414.1 | 15 | 0.40 | 19.9 | 0.482 |
| SEQ ID NO: 5 | BC012945.1 | 38 | 0.33 | 18.4 | 0.570 |
| SEQ ID NO: 6 | BC014409.1 | . | 0.32 | 10.7 | 0.448 |
| SEQ ID NO: 7 | BC015219.1 | 76 | 0.29 | 15.6 | 0.652 |
| SEQ ID NO: 8 | BC016470.2 | 74 | 0.19 | 14.6 | 0.579 |
| SEQ ID NO: 9 | BC018206.1 | 31 | 0.38 | 16.1 | 0.551 |
| SEQ ID NO: 10 | BC018404.1 | 93 | 0.27 | 19.0 | 0.754 |
| SEQ ID NO: 11 | BC019039.2 | 33 | 0.41 | 17.2 | 0.544 |
| SEQ ID NO: 12 | BC019315.1 | 27 | 0.48 | 17.8 | 0.846 |
| SEQ ID NO: 13 | BC021189.2 | 29 | 0.34 | 17.2 | 0.488 |
| SEQ ID NO: 14 | BC023152.1 | 6 | 0.10 | 25.3 | 0.752 |
| SEQ ID NO: 15 | BC026175.1 | 50 | 0.39 | 15.6 | 0.582 |
| SEQ ID NO: 16 | BC026346.1 | 78 | 0.48 | 16.4 | 0.360 |
| SEQ ID NO: 17 | BC032825.2 | 13 | 0.10 | 18.9 | 0.491 |
| SEQ ID NO: 18 | BC033711.1 | 72 | 0.29 | 14.6 | 0.567 |
| SEQ ID NO: 19 | BC036123.1 | 101 | 0.35 | 15.0 | 0.649 |
| SEQ ID NO: 20 | BC040949.1 | 45 | 0.37 | 17.9 | 0.523 |
| SEQ ID NO: 21 | BC050377.1 | 70 | 0.14 | 11.0 | 0.310 |
| SEQ ID NO: 22 | BC052805.1 | 56 | 0.29 | 16.6 | 0.501 |
| SEQ ID NO: 23 | BC053602.1 | 42 | 0.32 | 16.1 | 0.621 |
| SEQ ID NO: 24 | BC060824.1 | 12 | 0.28 | 19.4 | 0.421 |
| SEQ ID NO: 25 | NM_015138.2 | 91 | 0.33 | 13.3 | 0.607 |
| SEQ ID NO: 26 | NM_175887.2 | 34 | 0.43 | 15.4 | 0.537 |
| SEQ ID NO: 27 | NM_000394.2 | 44 | 0.38 | 20.2 | 0.737 |
| SEQ ID NO: 28 | NM_000723.3 | 200 | 0.22 | 9.4 | 0.580 |
| SEQ ID NO: 29 | NM_001008220.1 | 17 | 0.22 | 21.7 | 0.405 |
| SEQ ID NO: 30 | NM_001106.2 | 22 | 0.41 | 20.3 | 0.303 |
| SEQ ID NO: 31 | NM_001312.2 | 81 | 0.42 | 13.2 | 0.619 |
| SEQ ID NO: 32 | NM_001537.1 | 84 | 0.49 | 23.5 | 0.733 |
| SEQ ID NO: 33 | NM_002737 | 73 | 0.47 | 10.0 | 0.300 |
| SEQ ID NO: 34 | NM_002740 | 79 | 0.28 | 12.4 | 0.620 |
| SEQ ID NO: 35 | NM_002744 | 3 | 0.42 | 22.4 | 0.215 |
| SEQ ID NO: 36 | NM_003907.1 | 57 | 0.37 | 14.8 | 0.440 |
| SEQ ID NO: 37 | NM_003910.2 | 63 | 0.12 | 12.7 | 0.594 |
| SEQ ID NO: 38 | NM_004064.2 | 54 | 0.20 | 13.8 | 0.422 |
| SEQ ID NO: 39 | NM_004394.1 | 58 | 0.48 | 16.3 | 0.641 |
| SEQ ID NO: 40 | NM_004845.3 | 30 | 0.25 | 18.0 | 0.432 |
| SEQ ID NO: 41 | NM_004965.3 | 97 | 0.46 | 11.4 | 0.648 |
| SEQ ID NO: 42 | NM_005030 | 95 | 0.41 | 14.2 | 0.683 |
| SEQ ID NO: 43 | NM_005246.1 | 77 | 0.22 | 9.3 | 0.625 |
| SEQ ID NO: 44 | NM_006007.1 | 80 | 0.24 | 13.3 | 0.417 |
| SEQ ID NO: 45 | NM_006218.2 | 90 | 0.24 | 8.2 | 0.573 |
| SEQ ID NO: 46 | NM_006628.4 | 66 | 0.29 | 15.0 | 0.538 |
| SEQ ID NO: 47 | NM_006819.1 | 4 | 0.22 | 17.9 | 0.356 |
| SEQ ID NO: 48 | NM_012472.1 | 11 | 0.49 | 23.0 | 0.578 |
| SEQ ID NO: 49 | NM_014240.1 | 19 | 0.44 | 18.9 | 0.459 |
| SEQ ID NO: 50 | NM_014245.1 | 18 | 0.29 | 22.9 | 0.676 |
| SEQ ID NO: 51 | NM_014460.2 | 21 | 0.32 | 19.7 | 0.414 |
| SEQ ID NO: 52 | NM_014622.4 | 65 | 0.49 | 15.7 | 0.566 |
| SEQ ID NO: 53 | NM_014891.1 | 32 | 0.23 | 19.1 | 0.343 |
| SEQ ID NO: 54 | NM_014943.3 | 71 | 0.16 | 12.7 | 0.519 |
| SEQ ID NO: 55 | NM_015149.2 | 96 | 0.18 | 11.4 | 0.665 |
| SEQ ID NO: 56 | NM_015417.2 | 8 | 0.12 | 19.3 | 0.353 |
| SEQ ID NO: 57 | NM_015509.2 | 43 | 0.23 | 12.8 | 0.554 |
| SEQ ID NO: 58 | NM_016096.1 | 41 | 0.28 | 16.0 | 0.516 |
| SEQ ID NO: 59 | NM_016520.1 | 60 | 0.38 | 13.3 | 0.471 |
| SEQ ID NO: 60 | NM_017855.2 | 69 | 0.29 | 14.2 | 0.578 |
| SEQ ID NO: 61 | NM_017949.1 | 49 | 0.16 | 16.2 | 0.630 |
| SEQ ID NO: 62 | NM_018326.1 | 26 | 0.39 | 17.5 | 0.254 |
| SEQ ID NO: 63 | NM_018584.4 | 7 | 0.37 | 21.7 | 0.448 |
| SEQ ID NO: 64 | NM_024718.2 | 103 | 0.17 | 11.0 | 0.495 |
| SEQ ID NO: 65 | NM_024826.1 | 20 | 0.41 | 17.8 | 0.328 |
| SEQ ID NO: 66 | NM_025241.1 | 48 | 0.43 | 13.2 | 0.268 |
| SEQ ID NO: 67 | NM_032345.1 | 85 | 0.16 | 13.4 | 0.765 |
| SEQ ID NO: 68 | NM_032368.3 | 39 | 0.36 | 19.2 | 0.635 |
| SEQ ID NO: 69 | NM_079420.1 | 51 | 0.45 | 14.0 | 0.643 |
| SEQ ID NO: 70 | NM_080390.3 | 86 | 0.23 | 15.3 | 0.582 |
| SEQ ID NO: 71 | NM_138623.2 | 67 | 0.12 | 14.4 | 0.538 |
| SEQ ID NO: 72 | NM_145796.2 | 64 | 0.26 | 11.4 | 0.590 |
| SEQ ID NO: 73 | NM_153757.1 | 46 | 0.46 | 16.8 | 0.402 |
| SEQ ID NO: 74 | NM_177973.1 | 10 | 0.26 | 18.5 | 0.290 |
| SEQ ID NO: 75 | NM_178010.1 | 9 | 0.31 | 16.8 | 0.124 |
| SEQ ID NO: 76 | NM_199124.1 | 28 | 0.38 | 14.0 | 0.252 |
| SEQ ID NO: 77 | NM_201262.1 | 14 | 0.27 | 17.5 | 0.118 |
| SEQ ID NO: 78 | NM_203284.1 | 5 | 0.31 | 26.9 | 0.277 |
| SEQ ID NO: 79 | NM_205853.1 | 25 | 0.44 | 17.7 | 0.208 |
| SEQ ID NO: 80 | NM_212540.1 | 75 | 0.17 | 12.4 | . |

The discriminant proteins of Table 2 were selected to discriminate an individual based on the primary criterion that the logarithms of the associated intensity signals appear as selected variables in a STEPDISC model. Several STEPDISC models were tested. One used only data from the first QA sample associated with each protein. A second model used only data from the other QA sample. A third model used average values, and a fourth used all the data (a total of 198 sets of protein intensity data from 99 non-blank arrays). The “SelOrdAll” column in Table 1 shows the order of selection of proteins from the fourth model. The values are ranked, so “1” corresponds to the first protein selected, “2” for the second, and so forth. The protein (SEQ ID NO: 6) with no value in this column was selected in a fifth STEPDISC model that used just data from subjects with replication (specifically, data from the two individuals with more than one array in the data set were used in this model). The fourth run identified a total of 197 proteins. The filter sought proteins among the first 100 selected using this model. For later protein lists that needed more proteins than just the 80, additional proteins selected in the first three STEPDISC models were included in the screening list.

The initial list was refined using three additional filters. First, proteins retained on the list had to have the between-subject standard deviation as the largest of the estimated standard deviations. The standard deviations for this filter were obtained using a conventional “components of variance” analysis for each protein that sought variation between subjects, arrays, spots on the array and the QA sampling variation. The ratio of the between-subject estimate divided by the QA sample standard deviation estimate is shown in the “sRatio” column of Table 1. This ratio was used as a further criterion in narrowing the selection (see further below).

The second criterion used in refining the list of discriminant proteins to get just 80 was related to the probability of detection. For the example embodiment of the disclosure, a median intensity of greater than 1500 was assumed to be required in order to observe the presence of antigen/antibody bonding for a protein. The fraction of array data exceeding 1500 was tabulated for each protein. In initial data screening, this fraction was required to be at least 0.1 and less than 0.9. If nearly all the sample intensities are invisible, or nearly all are visible, there is less potential for discriminating between people. The minimum of the probability of visibility, and 1-this probability, was used further as described below. This attribute of a protein is denoted as “MinPSeeOrNot” in Table 2.

To determine the subset of 45 discriminant proteins listed in Table 3 below, pairwise correlation coefficients for all pairs among the 80 proteins were evaluated. The correlations were estimated using the data set of people with just one array per person (92 arrays), so that complete independence in the results would be ideal. The correlations were estimated using JMP® statistical software from SAS Institute. For each of the 80 proteins, a maximum correlation was identified. The pair of proteins in the array with the maximum correlation of all of these was identified. The protein in this pair with other relatively high correlations was identified as the worst protein from the correlation standpoint. This protein was recorded and then all correlations associated with it were removed from further consideration. This process was repeated using the remaining data, leading to identification of the second-worst protein and its highest correlation, conditioned on the first (worst) protein being omitted. This process was repeated until only two proteins remained in the set of data being considered. These are the two most “independent” proteins among the set of 80. The maximum correlation estimated between a given protein and some other protein, given that the more highly-correlated proteins have been removed from the data set, is shown as “MaxCorrAfter” in Table 2. The most discriminating proteins have the lowest values for “MaxCorrAfter.”

The 45 discriminant proteins in Table 2 were identified using the following cutoff values for the three filters discussed above: sRatio greater than or equal to about 11, a “MaxCorrAfter” less than about 0.6, and “MinPSeeOrNot” greater than about 0.2. The numbers in this filter were selected by trial and error to retain exactly 45 proteins.

TABLE 3
45 proteins, sorted on sRatio.

| Protein ID | SEQ ID NO | selOrdAll | MinPSeeOrNot | sRatio | maxCorrAfter |
|---|---|---|---|---|---|
| NM_203284.1 | SEQ ID NO: 78 | 5 | 0.3131 | 26.9 | 0.277 |
| NM_012472.1 | SEQ ID NO: 48 | 11 | 0.4949 | 23.0 | 0.578 |
| NM_002744 | SEQ ID NO: 35 | 3 | 0.4192 | 22.4 | 0.215 |
| NM_018584.4 | SEQ ID NO: 63 | 7 | 0.3737 | 21.7 | 0.448 |
| NM_001008220.1 | SEQ ID NO: 29 | 17 | 0.2172 | 21.7 | 0.405 |
| NM_001106.2 | SEQ ID NO: 30 | 22 | 0.4091 | 20.3 | 0.303 |
| BC011414.1 | SEQ ID NO: 4 | 15 | 0.4040 | 19.9 | 0.482 |
| NM_014460.2 | SEQ ID NO: 51 | 21 | 0.3182 | 19.7 | 0.414 |
| BC060824.1 | SEQ ID NO: 24 | 12 | 0.2828 | 19.4 | 0.421 |
| NM_014891.1 | SEQ ID NO: 53 | 32 | 0.2323 | 19.1 | 0.343 |
| NM_014240.1 | SEQ ID NO: 49 | 19 | 0.4444 | 18.9 | 0.459 |
| NM_177973.1 | SEQ ID NO: 74 | 10 | 0.2576 | 18.5 | 0.290 |
| BC012945.1 | SEQ ID NO: 5 | 38 | 0.3333 | 18.4 | 0.570 |
| NM_004845.3 | SEQ ID NO: 40 | 30 | 0.2525 | 18.0 | 0.432 |
| NM_006819.1 | SEQ ID NO: 47 | 4 | 0.2222 | 17.9 | 0.356 |
| BC040949.1 | SEQ ID NO: 20 | 45 | 0.3737 | 17.9 | 0.523 |
| NM_024826.1 | SEQ ID NO: 65 | 20 | 0.4141 | 17.8 | 0.328 |
| NM_205853.1 | SEQ ID NO: 79 | 25 | 0.4394 | 17.7 | 0.208 |
| NM_018326.1 | SEQ ID NO: 62 | 26 | 0.3939 | 17.5 | 0.254 |
| NM_201262.1 | SEQ ID NO: 77 | 14 | 0.2727 | 17.5 | 0.118 |
| BC021189.2 | SEQ ID NO: 13 | 29 | 0.3434 | 17.2 | 0.488 |
| BC019039.2 | SEQ ID NO: 11 | 33 | 0.4091 | 17.2 | 0.544 |
| NM_178010.1 | SEQ ID NO: 75 | 9 | 0.3081 | 16.8 | 0.124 |
| NM_153757.1 | SEQ ID NO: 73 | 46 | 0.4596 | 16.8 | 0.402 |
| BC052805.1 | SEQ ID NO: 22 | 56 | 0.2879 | 16.6 | 0.501 |
| BC026346.1 | SEQ ID NO: 16 | 78 | 0.4798 | 16.4 | 0.360 |
| BC018206.1 | SEQ ID NO: 9 | 31 | 0.3838 | 16.1 | 0.551 |
| NM_016096.1 | SEQ ID NO: 58 | 41 | 0.2828 | 16.0 | 0.516 |
| NM_014622.4 | SEQ ID NO: 52 | 65 | 0.4899 | 15.7 | 0.566 |
| BC026175.1 | SEQ ID NO: 15 | 50 | 0.3889 | 15.6 | 0.582 |
| BC010125.1 | SEQ ID NO: 3 | 62 | 0.2323 | 15.6 | 0.500 |
| NM_175887.2 | SEQ ID NO: 26 | 34 | 0.4293 | 15.4 | 0.537 |
| NM_080390.3 | SEQ ID NO: 70 | 86 | 0.2273 | 15.3 | 0.582 |
| NM_006628.4 | SEQ ID NO: 46 | 66 | 0.2929 | 15.0 | 0.538 |
| NM_003907.1 | SEQ ID NO: 36 | 57 | 0.3737 | 14.8 | 0.440 |
| BC033711.1 | SEQ ID NO: 18 | 72 | 0.2929 | 14.6 | 0.567 |
| NM_017855.2 | SEQ ID NO: 60 | 69 | 0.2879 | 14.2 | 0.578 |
| NM_199124.1 | SEQ ID NO: 76 | 28 | 0.3788 | 14.0 | 0.252 |
| NM_004064.2 | SEQ ID NO: 38 | 54 | 0.2020 | 13.8 | 0.422 |
| PM_2151 | SEQ ID NO: 2 | 99 | 0.2475 | 13.4 | 0.585 |
| NM_016520.1 | SEQ ID NO: 59 | 60 | 0.3838 | 13.3 | 0.471 |
| NM_006007.1 | SEQ ID NO: 44 | 80 | 0.2424 | 13.3 | 0.417 |
| NM_025241.1 | SEQ ID NO: 66 | 48 | 0.4343 | 13.2 | 0.268 |
| NM_015509.2 | SEQ ID NO: 57 | 43 | 0.2273 | 12.8 | 0.554 |
| NM_145796.2 | SEQ ID NO: 72 | 64 | 0.2576 | 11.4 | 0.590 |

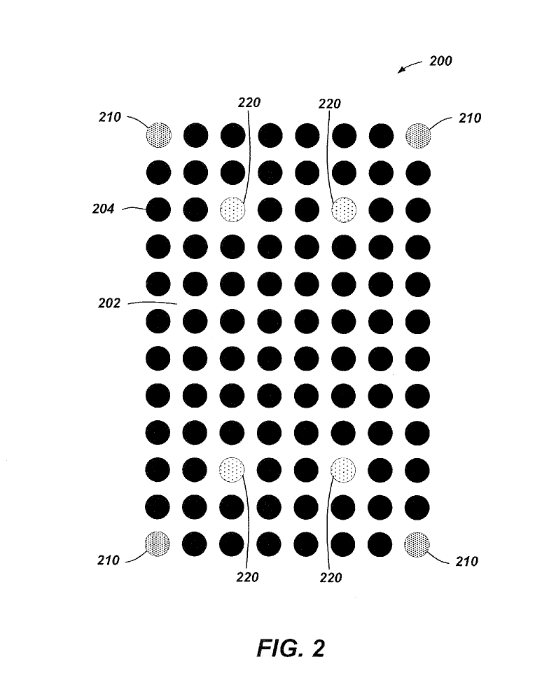

FIG. 2 shows a protein array 200 including control spots 210 and volume assessment spots 220 according to one or more embodiments of the present disclosure. As with the embodiment of FIG. 1, a support 204 includes a plurality of spots 202 arranged in an array. These spots may include any of the proteins as described above and be arranged in any of the arrangements described above.

Control spots 210 may be included in the embodiment of FIG. 2. The control spots 210 may be used during image capture and analysis of the protein array 200 as an image registration tool to assist the image capture and analysis tools determination of where other spots 204 in the protein array 200 are relative to the control spots 210. FIG. 2 illustrates the control spots 210 in the corners of the protein array 200. However, the control spots 210 may be positioned at any known locations within the protein array 200 such that registration of other spots 204 relative to the control spots 210 can be performed. Moreover, a different number of control spots 210 may be used in the protein array 200. As another non-limiting example, the control spots 210 may be positioned to minimize the distance between other spots 204 relative to a nearest control spot 210.

The control spots 210 may also be used to indicate if the antibody profile test is working correctly when samples are analyzed. As a non-limiting example, the control spots 210 may be printed with human Immunoglobulin G (IgG) onto the protein array 200. A detection agent may be used to bind with the human IgG of the control spots 210 to form the control complexes. As a result, after completion of the AbP process, if these control spots 210 show a signal, regardless of which individual the sample is from, the identifying steps using the detection agent for the test were done correctly and the test results may be considered valid.

Volume assessment spots 220 also may be included in the embodiment of FIG. 2. Contacting the biological sample with the volume assessment spots 220 the protein array forms volume complexes. Each volume assessment spot 220 may include a predetermined concentration of one or more volume determination proteins. It may be desirable to verify that enough of the biological sample was present in the AbP test to give an accurate result. The volume available from a biological sample can have a huge range. If enough of the biological sample is not utilized, the AbP test may give an invalid result. Volume assessment spots 220 including the volume determination proteins may be used to indicate that the biological sample has sufficient volume to give an accurate result. For this purpose, the volume determination proteins may include two types of protein printed onto the support 202, such as, for example, donkey anti-human Immunoglobulin G and protein G. Both of these proteins will bind human IgG antibodies. The two proteins may be titered with a concentration that will produce a signal when there is enough of the biological sample present.

For example, in analysis to determine a suitable concentration, an analysis support may include many different concentrations of the volume determination proteins. Then, different amounts of serum may be contacted with the volume determination proteins. Analysis can determine which concentrations would be suitable to indicate that a minimum amount of serum has been used to produce accurate results for an AbP test. This determined concentration for the volume assessment spots 220 may then be used on an AbP protein array 200 and will indicate with a detectable signal if a sufficient volume of sample has been used in an AbP test.

The location of the volume assessment spots 220 in the protein array 200 of FIG. 2 are examples of one embodiment. Many different locations and number of volume assessment spots 220 may be used.

For the general spots 204 (i.e. not the control spots 210 or volume assessment spots 220), the amount of protein printed for each spots 204 may be determined empirically and varied for each spot. Some proteins may give a much stronger signal than others may. As a result, these spots 204 may be titered to a lower concentration relative to an average concentration to allow a response that is not saturated. Conversely, low response proteins may be printed at higher concentrations relative to an average concentration to give signals for these proteins that are above a background and improve signal-to-noise ratio.

The size of protein spots 204 on the protein array 200 may be significant for the optimal function of the AbP test. Large spots 204 (e.g., about 600 microns) may give a higher signal and better statistical analysis, but may also have a larger variation in size from print run to print run and within a print run. This larger variation may create inconsistencies between AbP tests and within the same AbP test. Small spots 204 (e.g., about 270 microns) may be more consistent between and within print runs, but often have signals that are too close to a background signal to produce accurate results. Some embodiments may use a spot size of about 340 microns as a balance between sufficient signal-to-noise ratio and sufficient repeatability between print runs.

The trend in the microarray community is to use smaller and smaller spots so that more proteins may be printed per slide. However, with AbP technology a relatively large spot size may produce more accurate and consistent results. With smaller spots sizes, it may be necessary to utilize fluorescent or luminescent detection, which may necessitate the use of expensive scanning systems for data analysis. Forensic laboratories are historically underfunded and may not be able to afford this type of equipment. Thus, for AbP tests it may be more cost effective to use a detection system based on color that can be captured by off the shelf desktop scanners that are readily available to forensic laboratories. Scanning for visible light colors on the protein array 200 may produce more accurate and consistent results with relatively larger spots 204 for use with commercial scanners with sufficient resolution to capture the signals of the larger spots 204.

Moreover, using color produces a more persistent (i.e., non-transient) result that will remain stable for a long time period relative to fluorescent or luminescent type detection systems. As a result, a protein array 200 using visible light colors may be rescanned at some future time if necessary. Fluorescent and luminescent signals are transient and are lost if not scanned within a short time window.

In some AbP processes, the rinsing protocols originally developed for a strip format may not produce acceptable results for a microarray format and may result in high levels of background signal. For example, during some acts in the process fluid may become trapped underneath the glass of a microarray slide and may not be washed away adequately. This trapped fluid may result in high background levels during analysis.

For some embodiments, the slides may be removed from the tray after certain steps (e.g., the blood incubation step and the antibody detection step). With the slides removed, the trays may be quickly rinsed with a buffer to remove trapped liquid and then the slides may be returned to the trays. This change in protocol substantially eliminates the background signal levels due to trapped fluid.

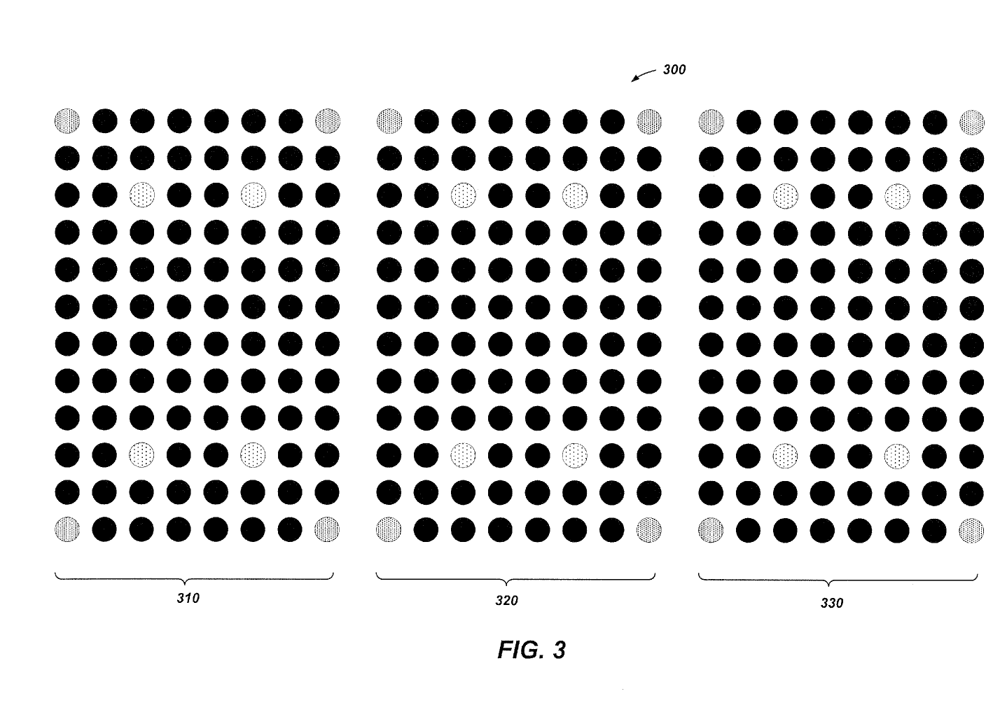

FIG. 3 shows a super array 300 including three protein arrays (310, 320, and 330) according to one or more embodiments of the present disclosure. As an alternate description, the super array 300 may be referred to as a protein array 300 and the protein arrays (310, 320, and 330) may be referred to as sub-arrays. The forensic science community may place significant requirements that results from a given test be statistically valid. Including multiple protein arrays (310, 320, 330) addresses the statistical validity issue by having three tests performed at the same time that should produce near identical (at least with statistical terms) results. Moreover, the results from each sub-array can then be averaged and utilized to perform various statistical analyses. The number of sub-arrays, and their relative positioning may vary greatly and be adjusted based on the type and accuracy of the statistical analysis desired.

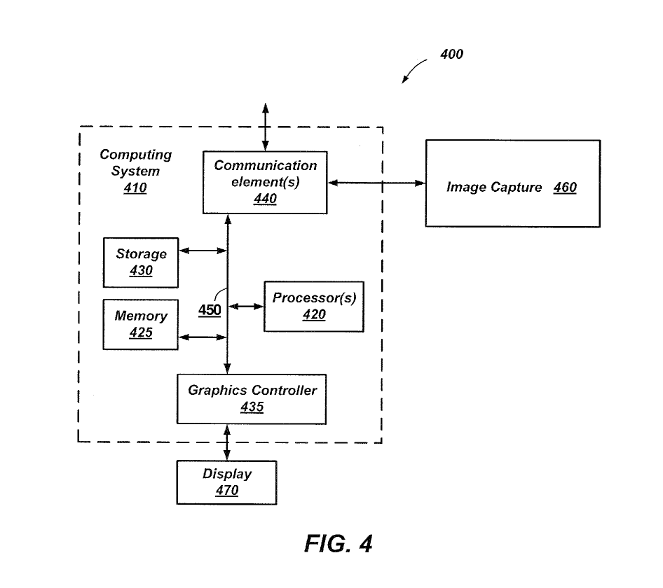

FIG. 4 is a simplified diagram of a system 400 for capturing and analyzing, image information for protein arrays. A computing system 410 is configured for executing software programs containing computing instructions and includes one or more processors 420, memory 425, one or more communication elements 440, and storage 430. The one or more processors 420 may be configured for executing a wide variety of operating systems and applications including the computing instructions for carrying out embodiments of the present disclosure.

The memory 425 may be used to hold computing instructions, data, and other information for performing a wide variety of tasks including performing embodiments of the present disclosure. By way of example, and not limitation, the memory 425 may include Synchronous Random Access Memory (SRAM), Dynamic RAM (DRAM), Read-Only Memory (ROM), Flash memory, and the like.

The communication elements 440 may be configured for communicating with other devices or communication networks (not shown). As non-limiting examples, the communication elements 440 may interface with external hardware and software (e.g., for cell or battery charging through an external device or grid) or for downloading stored data to an external data logger, or computer. By way of example, and not limitation, the communication elements 440 may include elements for communicating on wired and wireless communication media, such as for example, serial ports, parallel ports, Ethernet connections, universal serial bus (USB) connections IEEE 1394 (“firewire”) connections, bluetooth wireless connections, 802.1 a/b/g/n type wireless connections, and other suitable communication interfaces and protocols.

The storage 430 may comprise a computer-readable storage medium for storing large amounts of non-volatile information for use in the computing system 410 and may be configured as one or more storage devices. By way of example, and not limitation, these storage devices may but are not limited to magnetic and optical storage devices such as disk drives, magnetic tapes, CDs (compact disks), DVDs (digital versatile discs or digital video discs), and other equivalent storage devices.

When executed as firmware or software, the instructions for performing the processes described herein may be stored on the storage 430 and/or other computer-readable medium. It will be appreciated by those skilled in the art that computer-readable media can be any available media that may be accessed by the computing system 410, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, erasable programmable ROM (“EPROM”), electrically-erasable programmable ROM (“EEPROM”), FLASH memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

By way of non-limiting example, computing instructions for performing the processes may be held on the storage 430, transferred to the memory 425 for execution, and executed by the processor 420. The processor 420, when executing computing instructions configured for performing the processes, constitutes structure for performing the processes as a special-purpose processor. In addition, some or all portions of the processes may be performed by hardware specifically configured for carrying out the processes.

The storage 430 and memory 425 are coupled to the processor 420 such that the processor 420 can read information from, and write information thereto. In the alternative, the storage medium may be integral to the processor 420. Furthermore, the processor 420, memory 425 and storage 430 may reside, in various combinations, in an ASIC or FPGA.

A graphics controller 435 is coupled to the processor 420 and to a display 470, which may present information about captured images and the processes described herein in the form of pictures, text, tables, graphs, and the like.

The elements of the computing system 410 are illustrated, for simplicity, as communicating across a bus 450. However, those of ordinary skill in the art will recognize that the computing system 410 may include many different busses for communication between the various elements.

An image capture device 460 may be included in the system 400 for capturing images of protein arrays and communicating the images to the computing system 410. The image capture device 460 may be any suitable device for providing image information in the form of digital or analog images to be sampled. As non-limiting examples, the image capture device 460 may be a camera or a scanner.

In some embodiments, to ensure image quality adequate for subsequent analysis, images may be captured with a resolution that allows at least about 100 pixels of useable information per spot on the protein array. As a non-limiting example, for a resolution of at about 1200 dots per inch a 250 micron spot would contain at least 100 pixels. In some embodiments, the image may be captured as a grayscale image including, for example, 8 or 16 bits of intensity values per pixel.

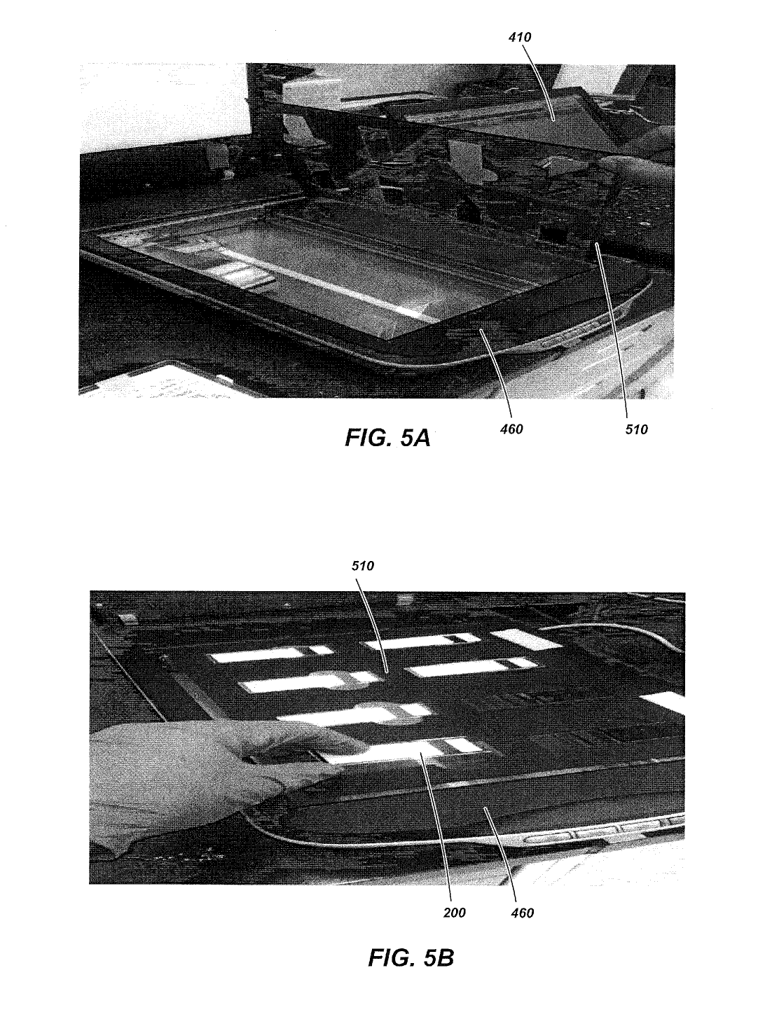

FIGS. 5A and 5B are images of a loading template 510 and an image capture device 460 in the form of a scanner for capturing image information for a plurality of protein arrays. As shown in FIG. 5A, the image capture device 460 is coupled to a computing system 410. When used with a scanner, and to achieve a good image, the loading template 510 may be configured to be placed on a bed of the scanner such that protein arrays 200 placed in the loading template 510 are held slightly off the glass of the scanner. FIG. 5A illustrates the loading template 510 pivoted up from the bed of the scanner to illustrate eight receiving apertures for receiving the protein arrays 200. FIG. 5B illustrates the loading template 510 pivoted down on to the bed of the scanner and shows a protein array 200 being placed in one of the receiving apertures of the loading template 510.

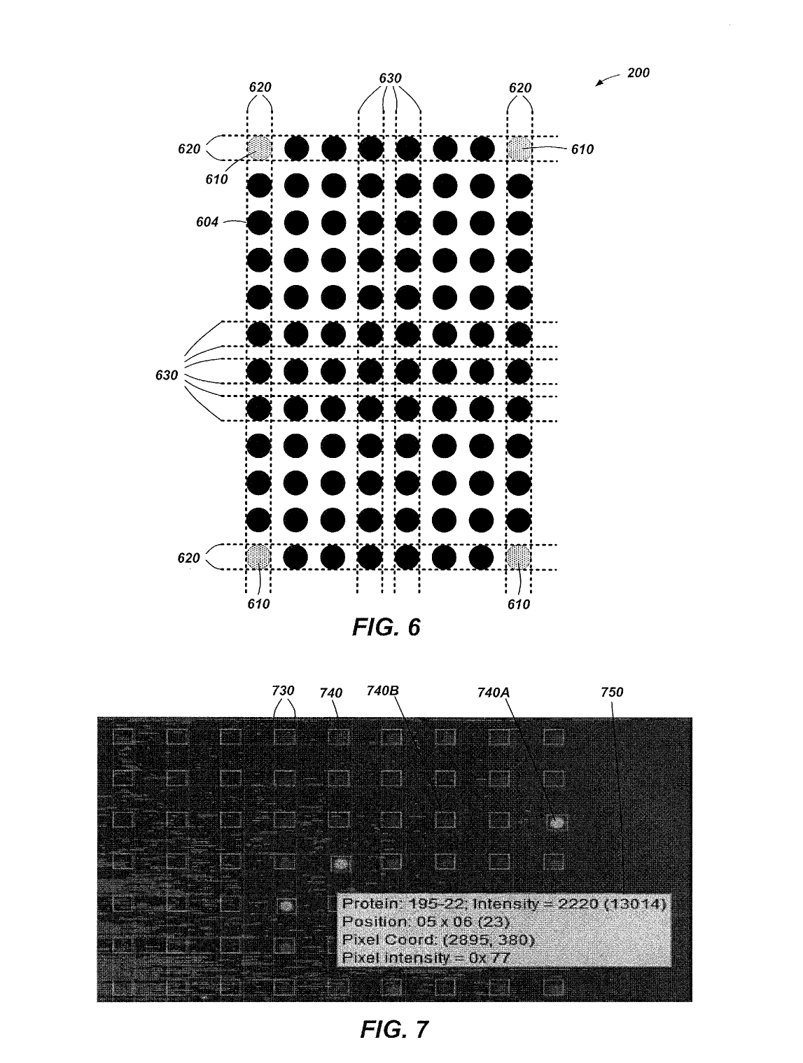

FIG. 6 shows a protein array 200 with alignment lines (620 and 630) relative to control spots 610. The protein array 200 includes spots 604 and control spots 610. As a non-limiting example, the control spots 610 are illustrated in the corners of the protein array 200. As stated earlier, on a properly processed protein array 200, the control spots 610 will always include a bright spot, whereas only some of the other spots will be bright. When an image of the protein array 200 is analyzed the intensity of the control spots 610 is easily identified and a grid of alignment lines (620 and 630) may be defined as on overlay for the image of the protein array 200. An analysis process may begin with prior knowledge of the expected size of the protein array 200, expected size of the spots (610 and 604), and expected arrangement of spots in the protein array 200. With this prior knowledge of the array configuration, control alignment lines 620 may be drawn both vertically and horizontally that substantially align with the perimeters of the control spots 610. These control alignment lines 620 define control locations where the control spots 610 are located. Also with the prior knowledge of the array configuration, field alignment lines 630 may be extrapolated from the control alignment lines 620 such that expected locations for each of spots 604 may be determined as encompassed by the extrapolated field alignment lines 630.

FIG. 7 is a screen image of a portion of a protein array 200 showing superimposed alignment lines 730 and spot locator boxes 740. These spot locator boxes 740 are formed by intersections of the alignment lines 730 and represent the expected location of the spots. Analysis of intensity of the spots may begin from these expected locations. For refinement, each expected location may be moved relative to its initial position for additional analysis if one or more of the spots is offset from its expected location. Spot locator box 740A shows a spot with a high intensity due to a reaction between the protein at that spot and the applied biological material. Spot locator box 740B shows a spot with a little or no intensity due to a lack of a reaction between the protein at that spot and the applied biological material.

The software running the analysis processes may be configured to show on display 470 an information box 750 for any selected spot and include information such as the protein at a specific location, the determined intensity of the spot, the position of the spot in coordinates of the protein array 200, the position of the spot in pixel coordinates as well as other information.

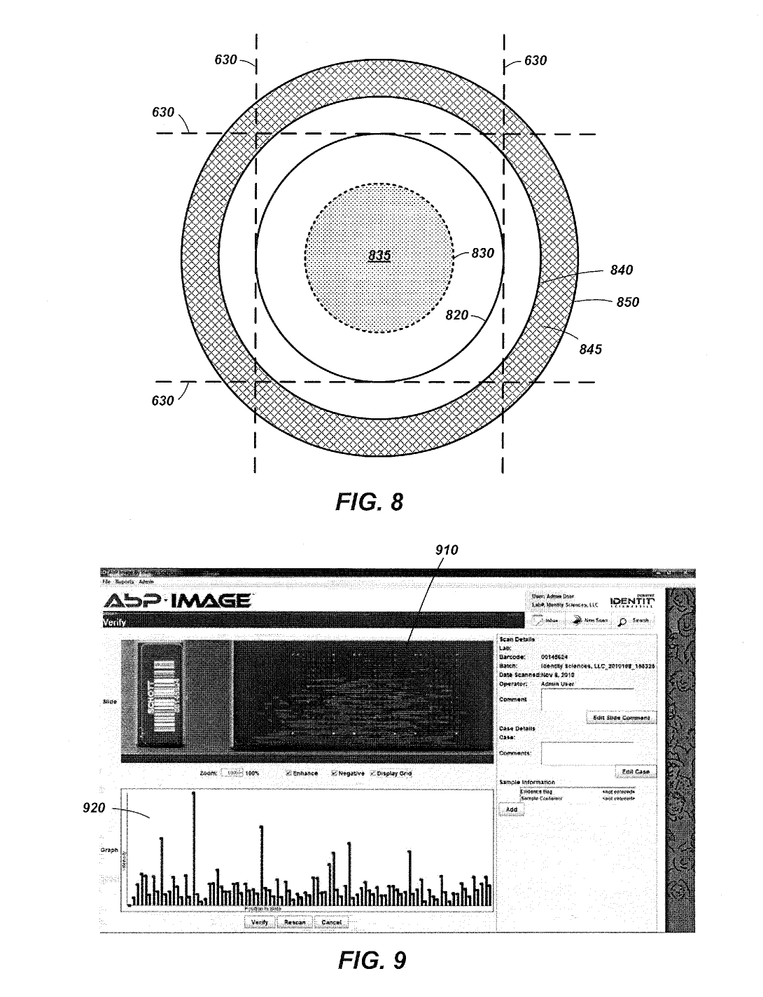

FIG. 8 shows a spot with alignment lines 630 and identification circles for identifying image locations of the spot 204 and background relative to the spot. A baseline circle 820 is defined by the alignment lines 630 and indicates a circle that is substantially centered on the expected location for each spot 204 and has a diameter that slightly exceeds a maximum diameter. This maximum diameter may be determined from analyzing spots 204 from other exposed protein array 200 and set to a diameter that would encompass near the largest of the analyzed spots.

A core 835 of the spot may be identified by an analysis circle 830. The analysis circle 830 may be defined as substantially concentric within the baseline circle 820 and includes a selected number of analysis pixels. As a non-limiting example, the selected number of analysis pixels may be as small as about 100 pixels, which would comprise an analysis circle 830 with a diameter of about 12 pixels or larger. Intensity values for each analysis pixel within the analysis circle 830 may be collected. In some embodiments, even though the spot may be quite a bit larger than the analysis circle 830, intensity values for pixels between the analysis circle 830 and the baseline circle 820 may not be gathered. With this analysis method, pixels around the margins of the spot, where there may be lower and less accurate intensity, are not used.

A background ring 845 may be defined as ring that is substantially concentric and outside the baseline circle 820 and includes a selected number of background pixels. An inner circle 840 of the background ring 845 may be defined to be outside the baseline circle 820 by, for example, a selected number of pixels. In one embodiment, the inner circle 840 of the background ring 845 may be defined to be at least two pixels beyond the baseline circle 820. An outer circle 850 of the background ring 845 may be defined such that the background ring 845 includes a selected number of background pixels. As a non-limiting example, the selected number of background pixels may be as small as about 100 pixels. Intensity values for each background pixel within the background ring 845 may be collected.

The intensity values of the analysis pixels may be averaged to determine a median pixel intensity and the intensity values of the background pixels may be averaged to determine a median background intensity. A difference between the median pixel intensity and the median background intensity may be defined as a median spot intensity. Determining the median spot intensity for all the spots on the protein array defines the numerical antibody profile for the presently analyzed biological material.

In some embodiments, the protein array may be configured to include multiple sub-arrays that include all the same proteins in the same locations. As one non-limiting example, the sub-arrays may be in triplicate on the protein array. In such protein arrays, the median spot intensity from each spot may be averaged with the corresponding median spot intensity from the other sub-arrays. This averaging of the median spot intensities may create a more statistically reliable numerical antibody profile.

FIG. 9 is a screen shot of a Graphical User Interface (GUI) illustrating a captured image 910 of a protein array and a graph 920 of intensity values for spots in the protein array. The GUI may include other information relative to the numerical antibody profile and may include interactive processes for the user to examine information about each spot as well as other statistical analysis information performed on the numerical antibody profile.

As a non-limiting example, the numerical antibody profile may be analyzed relative to other antibody profiles in a database. Thus, the processes discussed herein can determine correlation values of the present antibody profile to other known antibody profiles in the database. As a non-limiting example, a Pearson's correlation may be performed on the present antibody profile and considered a match with another antibody profile in the database if a result of the Pearson's correlation is higher than a selected correlation range. As one example, a correlation greater that about 90% to 93% may be considered a match.

In one embodiment, the antibody profiles in a database make up GAL info. The GAL info is a standard file format which describes the content and layout of the slide/image. It may be used to define, among other things, how many rows/columns are in a grid, their sizes, which protein is in each cell of the grid, and how many clones of the grid exist.

A barcode location and size may be used to narrow down the rest of the image processing steps, in one aspect, the barcode defines an “exclusion region.” Using the barcode to identify location and orientation provides measurable benefits with respect to performance.

A barcode may be found by using information about where the barcode is expected to be or configured, including e.g. acceptable barcode types, location: side, top, etc. Then, based on where the barcode is found, its type and orientation, a complete understanding of the orientation of the image may be obtained, and a narrower region of the image in which to expect the spots may be determined. The barcode is also associated with a particular GAL (GAL defines a range of barcode values to which it applies). In one embodiment, there is more than one GAL, and thus more than one way to layout slides.

Once the barcode is found with its associated GAL, the image, grid arrays, etc., can be determined, which result in significant performance gains. For example, the GAL can confirm if the grid has unused spots which can safely be ignored. This is also a performance gain because there is less “data” to store. The GAL can confirm the names of the proteins used in the UI, as well as during comparison of slides.

In one embodiment, two slides may have a different layout, as specified via different GAL files. The comparison of the slides may be done by comparing the matching proteins, as opposed to comparing proteins located at the same grid locations. This provides a great deal of flexibility and future-proofing of the underlying technology and the software application.

In another embodiment, 2D barcodes may be used. However, 2D barcodes are less preferred than 3D. This is because if one zooms in an image of a slide with a 2D barcode, the “squares” are fudged and blurry, and the image is more grayscale than it is black/white, and that may leave the barcode scanner guessing. There are ways to improve their performance. This involves determining the location, rotation, size of the 2D barcode, then removing noise and creating a replacement with 0 rotation and perfect squares/rectangles. This “clean-up” creates a “perfect” replacement, so the barcode library can extract the right value without a problem.

After the slide image is taken and the region with the barcode is excluded, other parameters may be configurable, such as: how much of a margin the slides have, tolerances, etc. Essentially, this step is trying to narrow down which part of the image that is focused on, both for performance reasons, and to help exclude spurious noise from the subsequent processing steps, such as scanning for control dots.

In one embodiment, control dots are identified by using a sequence of carefully selected image processing algorithms intended to reduce noise without losing too much information. This ultimately creates an extremely contrast enhanced (black/white) version of the region of the slide of interest. From this, only the most prominent control-spot candidates are extracted. These would be spots that are within tolerances of expected size/location (re: GAL). This involves scanning the image for features with specific traits, and performing fail-fast exits when something is obviously beyond expectation. For example, sometimes the edge of the paper leaves quite an impression. Once the algorithm notices that it's following a long line, it stops, and marks the region for exclusion, or sometimes there is a large bit of dirt or hair, etc.

Then, the list of potential control spots is analyzed heavily, though some random noise occasionally still makes it this far. Characteristics of the spots are examined, for example: how round the spot is, if it fits in an overall pattern of a grid with other spots, how close/far to other spots, rotational cohesion issues, etc. From this analysis, the set of grids is determined, each independent of the others, allowing for each to be of varying size/rotation within configured tolerances. In one embodiment, three copies of “the grid” are used on a slide, but this too is configurable (GAL).

After the control spots 610 are obtained, and potentially some of the more prominent spots 204, the enhanced image is no longer required. This is because most non-control spots were removed during this step. This enhanced image may be discarded.

After the foregoing steps, the expected locations of all remaining spots may be determined. The GAL may define how many rows, columns, widths, heights, and gaps between the spots there are. Based on the locations of the control spots 610 and their alignment with the GAL, the rest of the grid may be readily determined (including rotational angle, etc). Next, an imaginary grid is set up defining the location of all remaining spots 204 within the grid(s), including which coordinates within the grid do not contain proteins, etc. Once the grid details are determined this way, the image regions containing proteins can be focused on.

In some embodiments, a subset of the original image is taken that contains the expected grid region for a given protein/spot, and the surrounding region, which includes enough space so as to cover more than expected tolerances of the size and location for spots 204. This region is then cloned and the various image processing techniques are performed without disturbing the original. The clone region may be analyzed by a number of image processing techniques designed to bring out the spot without losing information or allowing noise to impact the result. Among the technique: a histogram is produced (global and local), local contrast enhancement applied, noise reduction, region/segmentation, feature detection, etc.

After a series of processing steps, an analysis is done to see if a spot of reasonable size and location can be found. If not, or if not “good enough”, the process is repeated several times, and the best match (if any) is selected. This process is repeated for each protein as defined in the GAL.

Occasionally, either the spot is not there (i.e., no reaction to the protein), or the spot is not discernible from the background noise. However, after repeating the process and gathering large data sets, a high level of accuracy may be obtained and only fails when the noise levels are very high, which may be attributable to dirt/hair in the image.

In one embodiment, a manual gridding option may be added. This would locate the grid as a whole, as opposed to individually locating and sizing each spot.

Once the best choice for the location and size of the dot is determined, it is contrasted with the surrounding background area, being careful not to include neighboring spots, to make a determination regarding its “intensity”. Sometimes, background noise may cause negative intensities.

All the information regarding size, location, intensity, and various statistical values for the spots 204 gets stored into the larger “slide/grid” data for later use/analysis. Once the entire slide is processed this way, all data gathered is saved to the database, including the original image (using lossless compression, so information isn't lost), time of image scan, etc.

It should be emphasized that the embodiments described herein are merely possible examples of implementations, merely set forth for a clear understanding of the principles of the present disclosure. Many variations and modifications may be made to the described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

One should note that conditional language, such as, among others, “can,” “could,” “might,” or “may,” unless specifically stated otherwise, or otherwise understood within the context as used, is generally intended to convey that certain embodiments include, while alternative embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment. Unless stated otherwise, it should not be assumed that multiple features, embodiments, solutions, or elements address the same or related problems or needs.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

What is claimed is:

1. A method for identifying a source of a biological material, comprising:
capturing an image of a protein array including spots of predetermined proteins, wherein some of the spots have bound to a sample of a biological material having individual-specific antibodies to form immune complexes and some of the immune complexes have interacted with a detection agent to generate a visible image therefrom;
processing the captured image of the protein array to determine control locations of a plurality of control spots at known locations on the protein array; and
extrapolating expected locations of all other spots on the protein array from the control locations.

2. The method of claim 1, further comprising, for each spot in the protein array:
determining a median pixel intensity for the spot as a median of pixel intensities from pixels within an analysis circle for the spot, wherein the analysis circle is substantially centered on the expected location for the spot;
determining a median background intensity for the spot as a median of pixel intensities from pixels within a background ring for the spot, wherein the background ring is substantially centered on the expected location for the spot and substantially concentric outside a baseline circle for the spot; and
determining a median spot intensity for the spot as a difference between the median pixel intensity and the median background intensity.

3. The method of claim 2, further comprising, for a plurality of sub-arrays within the protein array:
repeating the acts of determining the median pixel intensity, determining the median background intensity, and determining the median spot intensity, wherein each sub-array of the plurality includes a similar array of predetermined proteins such that each spot from a sub-array corresponds with a spot of another sub-array; and
averaging the median spot intensity for corresponding spots from each of the sub-arrays.

4. The method of claim 3, further comprising:
determining an antibody profile from all the median spot intensities values for all the spots of the protein array;
performing a statistical correlation to other known antibody profiles from a database; and
determining if there is a match in the database to the antibody profile responsive to the statistical correlation.

5. The method of claim 1, further comprising identifying a baseline circle for each spot of the protein array wherein the baseline circle is substantially centered on the expected location for each spot and has a diameter that slightly exceeds a maximum diameter determined from analyzing spots from other exposed protein arrays.

6. The method of claim 5, further comprising determining a median pixel intensity from an analysis circle for each spot, wherein the analysis circle is substantially concentric within the baseline circle and includes a selected number of analysis pixels.

7. The method of claim 6, wherein the analysis pixels comprise 100 pixels.

8. The method of claim 5, further comprising determining a median background intensity from a background ring for each spot, wherein the background is substantially concentric outside the baseline circle and includes a selected number of background pixels.

9. The method of claim 8, wherein the background pixels comprise 100 pixels.

10. The method of claim 1, wherein capturing the image of the protein array includes capturing images of the plurality of control spots within the protein array, wherein each of the control spots include human Immunoglobulin G that have interacted with the detection agent form control complexes and to generate a visible image therefrom.

11. A system, comprising:
an image capture device configured to capture an image of a protein array including spots of predetermined proteins, wherein some of the spots have bound to a biological material having individual-specific antibodies to form immune complexes and some of the immune complexes have interacted with a detection agent to generate a visible image therefrom; and
a computing system operably coupled to the image capture device and configured to:
process the captured image of the protein array to determine control locations of a plurality of control spots in known locations on the protein array; and
extrapolate expected locations of all other spots on the protein array from the control locations.

12. The system of claim 11, wherein the computing system is further configured to, for each spot in the protein array:
determine a median pixel intensity for the spot as a median of pixel intensities from pixels within an analysis circle for the spot, wherein the analysis circle is substantially centered on the expected location for the spot;
determine a median background intensity for the spot as a median of pixel intensities from pixels within a background ring for the spot, wherein the background ring is substantially centered on the expected location for the spot and substantially concentric outside a baseline circle for the spot; and
determine a median spot intensity for the spot as a difference between the median pixel intensity and the median background intensity.

13. The system of claim 12, wherein the computing system is further configured to, for a plurality of sub-arrays within the protein array:
repeat the acts of determining the median pixel intensity, determining the median background intensity, and determining the median spot intensity, wherein each sub-array of the plurality includes a similar array of predetermined proteins such that each spot from a sub-array corresponds with a spot of another sub-array; and
average the median spot intensity for corresponding spots from each of the sub-arrays.

14. The system of claim 13, wherein the computing system is further configured to:
determine an antibody profile from all the median spot intensities values for all the spots of the protein array;
perform a statistical correlation to other known antibody profiles from a database; and
determine if there is a match in the database to the antibody profile responsive to the statistical correlation.

15. The system of claim 11, wherein the computing system is further configured to identify a baseline circle for each spot of the protein array wherein the baseline circle is substantially centered on the expected location for each spot and has a diameter that slightly exceeds a maximum diameter determined from analyzing spots from other exposed protein arrays.

16. The system of claim 15, wherein the computing system is further configured to determine a median pixel intensity from an analysis circle for each spot, wherein the analysis circle is substantially concentric within the baseline circle and includes a selected number of analysis pixels.

17. The system of claim 16, wherein the computing system is further configured to determine a median background intensity from a background ring for each spot, wherein the background is substantially concentric outside the baseline circle and includes a selected number of background pixels.

18. The system of claim 17, wherein the computing system is further configured to determine a median spot intensity as a difference between the median pixel intensity from the analysis circle and the median background intensity from the background ring.

19. The system of claim 11, wherein the image capture device is configured to capture images of the plurality of control spots within the protein array, wherein each of the control spots include human Immunoglobulin G and have interacted with the detection agent to form control complexes and generate a visible image therefrom.

20. A computer-readable storage medium having computer-executable instructions stored thereon that, when executed on one or more processors, cause the one or more processors to:
receive a captured image of a protein array including spots of predetermined proteins, wherein some of the spots have bound to a sample of a biological material having individual-specific antibodies to form immune complexes and some of the immune complexes have interacted with a detection agent to generate a visible image therefrom;
process the captured image of the protein array to determine control locations of a plurality of control spots at known locations on the protein array; and
extrapolating expected locations of all other spots on the protein array from the control locations.

21. The computer-readable storage medium of claim 20, having further computer-executable instructions stored thereon that cause the one or more processors to, for each spot in the protein array:
determine a median pixel intensity for the spot as a median of pixel intensities from pixels within an analysis circle for the spot, wherein the analysis circle is substantially centered on the expected location for the spot;
determine a median background intensity for the spot as a median of pixel intensities from pixels within a background ring for the spot, wherein the background ring is substantially centered on the expected location for the spot and substantially concentric outside a baseline circle for the spot; and
determine a median spot intensity for the spot as a difference between the median pixel intensity and the median background intensity.

22. The computer-readable storage medium of claim 21, having further computer-executable instructions stored thereon that cause the one or more processors to, for a plurality of sub-arrays within the protein array:
repeating the acts of determining the median pixel intensity, determining the median background intensity, and determining the median spot intensity, wherein each sub-array of the plurality includes a similar array of predetermined proteins such that each spot from a sub-array corresponds with a spot of another sub-array; and
averaging the median spot intensity for corresponding spots from each of the sub-arrays.

23. The computer-readable storage medium of claim 22, having further computer-executable instructions stored thereon that cause the one or more processors to:
determine an antibody profile from all the median spot intensity values for all the spots of the protein array;
perform a statistical correlation to other known antibody profiles from a database; and
determine if there is a match in the database to the antibody profile responsive to the statistical correlation.

24. The computer-readable storage medium of claim 20 having further computer-executable instructions stored thereon that cause the one or more processors to identify a baseline circle for each spot of the protein array wherein the baseline circle is substantially centered on the expected location for each spot and has a diameter that slightly exceeds a maximum diameter determined from analyzing spots from other exposed protein arrays.

25. The computer-readable storage medium of claim 24, having further computer-executable instructions stored thereon that cause the one or more processors to determine a median pixel intensity from an analysis circle for each spot, wherein the analysis circle is substantially concentric within the baseline circle and includes a selected number of analysis pixels.

26. The computer-readable storage medium of claim 25, having further computer-executable instructions stored thereon that cause the one or more processors to determine a median background intensity from a background ring for each spot, wherein the background is substantially concentric outside the baseline circle and includes a selected number of background pixels.

27. The computer-readable storage medium of claim 26, having further computer-executable instructions stored thereon that cause the one or more processors to determine a median spot intensity as a difference between the median pixel intensity from the analysis circle and the median background intensity from the background ring.
